(19) United States
(12) Patent Application Publication
(10) Pub. No.: US 2014/0279695 A1
(43) Pub. Date: Sep. 18, 2014

(54) SYSTEM AND METHOD FOR RATING AND SELECTING MODELS

(71) Applicant: National Cheng Kung University, Tainan City (TW)

(72) Inventors: Yu-Chin HSU, Luzhu Township (TW); Chung-Ming KUAN, Taipei (TW); Meng-Feng YEN, Tainan City (TW)

(73) Assignee: National Cheng Kung University, Tainan City (TW)

(21) Appl. No.: 14/212,149

(22) Filed: Mar. 14, 2014

Related U.S. Application Data
(60) Provisional application No. 61/791,458, filed on Mar. 15, 2013.

(51) Int. Cl. G06Q 40/06

(52) U.S. Cl. CPC G06Q 40/06
USPC 705/36 R

(57) ABSTRACT

Computer-implemented method and system are provided to identify superior models relative to a benchmark model in a step-wise fashion while reducing data snooping bias and increasing the test power. The data snooping bias may be reduced or avoided by controlling, in a step-wise fashion, a measure of error such as generalized family-wise error rate (FWER) and/or false discovery proportion (FDP). The test power of the method may be increased by relaxing the generalized FWER to tolerate more falsely rejected models and applying re-centering techniques to account for the inclusion of potentially “poor” models in the evaluation.

### CROSS-REFERENCE TO RELATED APPLICATIONS

This application claims the benefit of U.S. Application Ser. No. 61/791,458, filed Mar. 15, 2013, which is hereby incorporated by reference in its entirety.

### BACKGROUND OF THE INVENTION

It is estimated that the daily global financial markets involve more than 2.5 quadrillion dollars in transactions including stocks, bonds, commodities, energy, currencies, and derivatives. Many of these transactions are managed by institutions, such as banks, mutual funds, hedge funds, investment banks, private equity holders, insurance companies, investment consultants, asset management companies, and professional traders. Some of the transactions are made by individual investors. Using various types of financial instruments, a number of financial models governing the trading and investment strategies have been developed. However, it remains difficult to evaluate performance of models and select the better performing ones. Moreover, when there are a large number of financial models available, it is extremely difficult to select the superior ones, especially with a high test power and without a data snooping bias. Therefore, it is necessary to develop a system to rank, rate and select superior financial models.

### SUMMARY OF THE INVENTION

Disclosed herein includes systems, devices, media and methods to select and rate a financial model with respect to a benchmark financial model. With the quantitative analysis described herein, the system can evaluate and select models with top performance with increasing test power and reduced data snooping bias. Advantages of the systems, devices, media and methods disclosed herein include enabling financial institutions to select the best models, rate the quality of models, formulate better investment/trading strategies, tailor models for customer needs, and obtain better investment/trading profits.

According to one aspect of the disclosure, a computer-implemented method for evaluating performance of models is provided. In one aspect, the method comprises receiving a request to evaluate performance of a plurality of models according to a performance metric, identifying one or more superior models from a plurality of models relative to a benchmark while reducing data snooping bias and improving test power, and displaying the one or more superior models. In one embodiment, data snooping bias is avoided by asymptotically controlling a generalized family-wise error rate (FWER) and/or false discovery proportion (FDP). In certain instances, the test power of the method is increased by applying re-centering techniques to the distributions to account for the effect of “poor” models.

According to another aspect of the disclosure, a computer system for evaluating performance of models is provided. In one aspect, the computer system comprises one or more processors, and memory, including instructions executable by the one or more processors to cause the computer system to at least receive a request, from a user interface, to evaluate performance of a plurality of models according to a performance metric, identify one or more superior models from a plurality of models relative to a benchmark while reducing data snooping bias and improving test power, and display, on the user interface, the one or more identified superior models.

According to another aspect of the disclosure, one or more non-transitory computer-readable storage media are provided. In one embodiment, the one or more non-transitory computer-readable storage media have stored thereon executable instructions that, when executed by one or more processors of a computer system, cause the computer system to at least receive a request, from a user interface, to evaluate performance of a plurality of models according to a performance metric, identify one or more superior models from a plurality of models relative to a benchmark while reducing data snooping bias and improving test power, and display, on the user interface, the one or more identified superior models.

According to another aspect of the disclosure, an electronics system for selecting superior financial models is provided. In one aspect, the electronics system comprises: one or more processors, and memory; a data reader to acquire data of a plurity of financial models; a benchmark model selector to determine at least one benchmark model; a statistical analyzer to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and a reporter to present one or more selected financial models. The components of the electronics systems are implemented by software modules, application specific integrated circuits (ASICs), field-programmable gate arrays (FPGAs), graphical processing units (GPUs), or a combination of the same.

### BRIEF DESCRIPTION OF THE DRAWINGS

FIG. 1 shows a non-limiting example of a computing system enabling financial model rating and selection; in this case, a server hosts a model selection module and allows multiple remote user devices to access selected superior models.

FIG. 2 shows a non-limiting example of a computing device for running the financial model rating and selection; in this case, a device comprising a processing unit, a network interface, a display, and memory storage performed statistical test algorithms to identify superior financial models.

FIG. 3 shows a non-limiting example of a network configuration for running the financial model rating and selection; in this case, a user device comprising a model selection module that accesses remote data storage via network to perform statistical test on superior financial selection.

FIG. 4 shows a non-limiting example flowchart of a model rating and selection for financial models; in this case, a device receives inputs from a user, retrieves data of financial models, and identifies and presents superior financial models.

FIG. 5 shows a non-limiting example of a statistical analysis flowchart; in this case, a device is given a performance metric, a plurality of financial models and test statistics, and then the algorithm evaluates if rejected hypotheses satisfies the criteria to end the statistical analysis.

FIG. 6 shows a non-limiting example of a statistical test algorithm; in this case, an algorithm is given false discovery proportion (FDP) threshold and significance level, and then the algorithm starts iterating rejecting bad models until the criteria are satisfied.

FIG. 7 shows a non-limiting example algorithm of a stepwise-superior-predictive-ability test controlling a generalized family-wise error rate; in this case, the algorithm initializes a counter and a set of rejected financial models, followed by recursively examining if the performance measures of the financial models are greater than derived critical values.

FIG. 8 shows a non-limiting example of a graphical user interface of the developed system; in this case, the user interface allowed a user to select: the type of financial model, a maximum number of hypotheses to be rejected, a factor model for performance evaluation, a time period for analysis, and a time frequency for analysis; and then the user interface further displayed the selected superior financial models.

FIG. 9 shows a non-limiting example of an experiment result; in this case, a developed system examined a portfolio of 240 mutual funds on a monthly basis and selected the superior mutual funds in the investment; the bar chart shows the monthly gains and the line curves show a 564% accumulated gains achieved by the disclosed system versus 91% accumulated gains of the MSCI World Stock Index from February 2005 to February 2014.

### DETAILED DESCRIPTION OF THE INVENTION

In one aspect, disclosed herein is a computer implemented method comprising: (a) acquiring by a computer the data of a plurity of financial models; (b) selecting by a computer at least one benchmark model; and (c) using by a computer a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate. The stepwise-superior-predictive-ability test in the method comprises: (a) initializing a counter to be one and a set of rejected financial models to be an empty set; (b) computing a test statistic for each financial model, wherein the test statistic comprises a performance measure of the financial model; (c) computing a critical value of one or more subsets of the financial models, wherein the one or more subsets of the financial models are defined by the counter and the set of rejected financial models; (d) rejecting a financial model whose test statistic is greater than the critical value; (e) terminating the stepwise-superior-predictive-ability test if the number of rejected financial models is smaller than the counter, or incrementing the counter by one and repeating step (c); and (f) presenting all rejected financial models as the superior models.

In another aspect, disclosed herein are non-transitory computer-readable storage media encoded with a computer program including instructions executable by a processor to create an application comprising: (a) a software module configured to acquire data of a plurity of financial models; (b) a software module configured to select at least one benchmark model, wherein the benchmark model is indicated by a user or automatically determined by the application; (c) a software module configured to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and (d) a software module configured to set one or more criteria for evaluating the performance. In some embodiments, the stepwise-superior-predictive-ability test comprises: (a) initializing a counter to be one and a set of rejected financial models to be an empty set; (b) computing a test statistic for each financial model, wherein the test statistic comprises a performance measure of the financial model; (c) computing a critical value of one or more subsets of the financial models, wherein the one or more subsets of the financial models are defined by the counter and the set of rejected financial models; (d) rejecting a financial model whose test statistic is greater than the critical value; (e) terminating the stepwise-superior-predictive-ability test if the number of rejected financial models is smaller than the counter, or incrementing the counter by one and repeating step (c); and (f) presenting all rejected financial models as the superior models. In some embodiments, the media comprise a software module configured to set an analysis frequency for the stepwise-superior-predictive-ability test to evaluate the financial models. In some applications, the media comprise a software module configured to set a performance metric for the stepwise-superior-predictive-ability test to evaluate the financial models. In some embodiments, the media comprise a software module configured to display the identified superior models. In certain cases, the media comprise a software module configured to control the access of a remote user to the identified superior models. In some scenarios, the media comprise a software module configured to link with a broker to allow a user to trade the identified superior models. The embodied financial models may comprise one or more of: investment portfolios, stocks, options, futures, swaps, foreign exchanges, exchange-traded funds, commodities, real estate, assets, commodity trading advisor funds, mutual funds, and hedge funds. In further embodiments, the software application is offered as a service.

In another aspect, disclosed herein is a computer-implemented system comprising: (a) a digital processing device comprising a memory device and an operating system configured to perform executable instructions; (b) a computer program including instructions executable by the digital processing device to create an application, wherein the application comprising: (1) a software module configured to acquire data of a plurity of financial models; (2) a software module configured to select at least one benchmark model, wherein the benchmark model is indicated by a user or automatically determined by the application; (3) a software module configured to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and (4) a software module configured to set one or more criteria for evaluating the performance. The stepwise-superior-predictive-ability test of the system comprises: (a) initializing a counter to be one and a set of rejected financial models to be an empty set; (b) computing a test statistic for each financial model, wherein the test statistic comprises a performance measure of the financial model; (c) computing a critical value of one or more subsets of the financial models, wherein the one or more subsets of the financial models are defined by the counter and the set of rejected financial models; (d) rejecting a financial model whose test statistic is greater than the critical value; (e) terminating the stepwise-superior-predictive-ability test if the number of rejected financial models is smaller than the counter, or incrementing the counter by one and repeating step (c); and (f) presenting all rejected financial models as the superior models. In some embodiments, the software application of the system comprises a software module configured to set an analysis frequency for the stepwise-superior-predictive-ability test to evaluate the financial models. In some cases, the software application of the system comprises a software module configured to set a performance metric for the stepwise-superior-predictive-ability test to evaluate the financial models. In certain applications, the software application of the system comprises a software module configured to display the identified superior models. In some scenarios, the software application of the system comprises a software module configured to control the access of a remote user to the identified superior models. Alternatively, the software application of the system comprises a software module configured to link to a broker to trade the identified superior models. The embodied financial models in the system comprise one or more of: investment portfolios, stocks, options, futures, swaps, foreign exchanges, exchange-traded funds, commodities, real estate, assets, commodity trading advisor funds, mutual funds, and hedge funds.

In another aspect, disclosed herein is an electronic system comprising: (a) a digital processing device comprising a memory device and an operating system configured to perform executable instructions; (b) a data reader configured by the digital processing device to acquire data of a plurity of financial models; (c) a benchmark model selector configured by the digital processing device to determine at least one benchmark model; (d) a statistical analyzer configured by the digital processing device to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and (e) a reporter configured by the digital processing device to present one or more selected financial models. The embodied stepwise-superior-predictive-ability test comprises: (a) initializing a counter to be one and a set of rejected financial models to be an empty set; (b) computing a test statistic for each financial model, wherein the test statistic comprises a performance measure of the financial model; (c) computing a critical value of one or more subsets of the financial models, wherein the one or more subsets of the financial models are defined by the counter and the set of rejected financial models; (d) rejecting a financial model whose test statistic is greater than the critical value; (e) terminating the stepwise-superior-predictive-ability test if the number of rejected financial models is smaller than the counter, or incrementing the counter by one and repeating step (c); and (f) presenting all rejected financial models as the superior models. In some embodiments, the electronic system is implemented in software modules, application specific integrated circuits (ASICs), field-programmable gate arrays (FPGAs), graphical processing units (GPUs), or a combination of the same.

### CERTAIN DEFINITIONS

Unless otherwise defined, all technical terms used herein have the same meaning as commonly understood by one of ordinary skill in the art to which this invention belongs. As used in this specification and the appended claims, the singular forms “a,” “an,” and “the” include plural references unless the context clearly dictates otherwise. Any reference to “or” herein is intended to encompass “and/or” unless otherwise stated.

### Financial Models

In some embodiments, the systems, devices, media and methods described herein include one or more financial models, or use of the same. In some embodiments, a financial model is a holding of one or more tradable assets. Non-limiting examples of assets include cash, real estate, securities, bills, notes, commercial papers, stocks, bonds, commodities, raw materials, precious metals, spot foreign exchanges, manufactured products, intellectual properties, and trademarks. The assets can be traded via one or more financial instruments. Non-limiting examples of financial instruments include cash, certificate of deposit, stocks, futures, options, swaps, agreements, forwards, credit cards, mutual funds, exchange traded funds, insurance, hedge funds, and commodity trading advisor funds. Various combinations of assets and financial instruments can be embodied to underlie different financial models.

In some embodiments, a financial model includes a rule to sell and buy one or more assets. The rule may be discretionary or systematic. In some cases, the model is represented by mathematical equations, or is a quantitative analysis on a set of financial and/or non-financial data. In some applications, a financial model is a combination of other models. By way of a non-limiting example, a hedge fund holds a portfolio of multiple mutual funds, each of which holds a number of stocks. Frequently, a financial model includes more than one type of assets and/or more than one financial instrument.

In some embodiments, a financial model includes a statistical tool to create a trading/investment rule and/or to evaluate the performance of the financial model. In certain instances, a hypothesis test is involved in the statistical tool. In certain instances, the statistical tool analyzes the entire, or a portion of, historical data of a financial model (or a non-financial model, or a combination of financial and non-financial models) to determine the current or future trading rules. Non-limiting examples of historical data include prices, volumes, times, periods, frequencies, economic data, demographic data, business data, military data, political data, weather data, and news. Other possible data types involved in a financial model are within the scope of embodiments. In further instances, the prices comprise open prices, highest prices, lowest prices, and/or close prices. In certain instances, the data analysis relies heavily on data, leading to data snooping bias. In some embodiments, the systems, devices, media and methods described herein include statistically testing one hypothesis, multiple hypotheses, or a large number of hypotheses to avoid the data snooping bias.

In some embodiments, a financial model includes periodic data collection. The frequency of data collection and/or data analysis may be very high to very low. Sometimes, the frequency is regular or irregular. The time period may be femtoseconds, 1 to 1000 microseconds, 1 to 10 milliseconds, 1 to 100 milliseconds, 1 to 1000 milliseconds, 1 second, 1 to 30 seconds, 1 to 60 seconds, 1 to 5 minutes, 1 to 15 minutes, 1 to 60 minutes, 1 to 4 hours, 1 to 8 hours, 1 to 24 hours, 1 to 5 days, 1 to 10 days, 1 to 20 days, 1 to 30 days, 1 month, 1 to 2 months, 1 to 3 months, 1 to 4 months, 1 to 6 months, 1 to 9 months, 1 to 12 months, 1 year, 1 to 2 years, 1 to 5 years, 1 to 10 years, 1 to 20 years, 1 to 30 years, or a combination of the same. In certain cases, the data collection takes place during trading sessions, after the trading session, or both of them. The trading sessions can be dependent on markets in a country/region or a combination of multiple countries/regions.

### Performance Metric

In some embodiments, the systems, devices, media and methods described herein include one or more performance metrics, or use of the same. Non-limiting examples of performance metrics include percentage of gain/loss, mean risk, drawdown, excess return, Sharpe ratio, alpha, standardized alpha, information ratio, GIS MPPM, and the like. In some cases, particular formulas are used to calculate or measure the performance of a model; non-limiting examples of formulas include CAPM, Brown-Geotzmann-Ibbotson 1-factor model, Fama-French 3-factor model, Fama-French-Carhart 4-factor model, Fung-Hsieh 5-factor model, Fung-Hsieh 7-factor model, Fung-Hsieh 8-factor model, Capocci-Hübner 11-factor model, and the like.

### Multiple Hypothesis Testing

In some embodiments, the systems, devices, media and methods described herein include a multiple hypothesis testing, or use of the same to avoid the drawbacks of data snooping bias. In certain instances, the multiple hypothesis testing identifies as many false null hypotheses as possible while accounting for the data-snooping effect. For example, among a given set of models such as portfolios, mutual funds, hedge funds or trading rules, one would like to know whether some models have superior performance relative to a benchmark. As a consequence, data snooping may arise because, when many models are evaluated individually, some are deemed to be superior by chance alone even though they are not. To avoid data snooping in multiple hypotheses testing, the systems described herein may use reality check (RC) method or stepwise RC (Step-RC) test that is capable of identifying significant models while controlling the family-wise error rate (FWER), which is known as the probability of at least one false rejection.

In some embodiments, the systems, devices, media and methods described herein include hypotheses that involve inequality constraints. In such embodiments, Step-RC may be conservative because it is based on the least favorable configuration (LFC) leading to dramatically losing statistical power when many “poor” models are included in the test. To circumvent this problem, the systems may adopt the re-centering method in the “superior predictive ability” (SPA) test that is able to remove those poor models from consideration asymptotically. The SPA test together with the stepwise procedure in Step-RC leads to a stepwise SPA (Step-SPA) test, generating a more powerful result than Step-RC especially when “poor” models are present.

In some embodiments, the systems, devices, media and methods described herein include a large number of hypotheses. A non-limiting example of a large number of hypothesis tests is that: which financial models out of more than 100 models are able to generate better gains than a benchmark model. When statistical testing involves a large number of hypotheses, incorrectly rejecting a few of them may not be a very serious problem in practice. Therefore, controlling only one false rejection poses a very stringent criterion. In view of this, one may lower the rejection criterion and hence increase the test power by tolerating more false rejections. Let k≧2 denote the number of false rejections. In some cases, the systems may tolerate k false rejections in the Step-RC and the Step-SPA methods, denoted as Step-RC(k) and Step-SPA(k), respectively. Step-RC(k) may be used because it can asymptotically control the generalized family-wise error rate (FWER(k)), which is the probability of k or more false rejections. Analogous to Step-SPA, Step-SPA(k) has asymptotic control of the FWER(k) and employs the re-centering method. The Step-SPA(k) method is consistent in that it can identify the violated null hypotheses with probability approaching one. In some applications, Step-SPA(k) generates better results than Step-RC(k) under any power notion.

In some embodiments, the systems, devices, media and methods described herein include a large number of hypotheses with control of false discovery proportion (FDP). FDP is the ratio of the number of false rejections over the number of total rejections. In such embodiments, Step-RC(k) and/or Step-SPA(k) method is employed to asymptotically control FDP.

### Mathematical Formulation of Financial Model Evaluation

In some embodiments, the systems, devices, media and methods described herein include a statistical modeling of one or more portfolios. To facilitate the understanding of the disclosure, the notations are first described, followed by the various hypothesis testing methods. Let θₑ be a performance measure of model e, e=1, . . . , m; there are in total m models. For example, θₑ may be the Capital Asset Pricing Model (CAPM) alpha of the e-th portfolio (e.g., a mutual fund, a hedge fund, a CTA funds, or a combination of assets) or the sample mean of the realized return of the e-th technical trading rule. Portfolios that have a positive CAPM alpha or the trading rules that generate positive mean returns are of interest. That is, the set is identified as E⁺≡{e: θₑ>0}. This amounts to testing the following inequality constraints: H₀^{e}:θₑ≦0, e=1, . . . , m. Under this formulation, a financial model being rejected its null hypothesis means that its performance is greater than a benchmark model.

Data snooping may arise when models are tested individually but without a proper control of the probability of false rejections. Thus, one may find some models with positive θₑ by chance alone, even though they are not. As a specific example, if there are 100 models that are mutually independent, and a t-test is applied to each model with the significance level 5%, the probability of falsely rejecting at least one correct null hypothesis is 1−(0.95)¹⁰⁰=0.994. It is thus highly likely that an individual test may incorrectly suggest an inferior model to be a significant one. Therefore, an appropriate method that can control such data-snooping bias is needed to avoid spurious inference when many models are examined together.

The disclosure described herein considers two assumptions. Let \hat{θ}ₙ=[\hat{θ}_{1,n}, . . . , \hat{θ}_{m,n}]^{T} be an estimator of θ=[θ₁, . . . , θₘ]^{T} in which n is the number of data observations. The first assumption assumes the following conditions hold:
(1-i)

$$\sqrt{n} ( {\hat{θ}}_{n} - θ ) {}^{d} N ( 0 , Ω )$$

where Ω is the m×m asymptotic covariance matrix of \hat{θ}ₙ, with the (i, j)-th element ωᵢⱼ. For some δ>0, the diagonal elements are ωᵢⱼ=σⱼ²≧δ,j=1, . . . , m.
(1-ii) There exists a consistent estimator \hat{Ω}ₙ for Ω whose (i, j)-th element is \hat{ω}_{ij,n} such that

$${\hat{ω}}_{ij , n} {->}^{P} {ω}_{ij} , i , j = 1 , … , m .$$

(1-iii)

$$\sqrt{n} {\hat{Λ}}_{n}^{- 1} ( {\hat{θ}}_{n} - θ ) {->}^{d} N ( 0 , Ξ ) ,$$

where \hat{Λ}ₙ=diag(\hat{σ}_{1,n}, . . . , \hat{σ}_{m,n}), \hat{σ}_{j,n}=\sqrt{\hat{ω}_{jj,n}}, and the (i, j)-th element of Ξ is ξᵢⱼ=ωᵢⱼ/(σᵢσⱼ), and

$${\hat{Ξ}}_{n} = {\hat{Λ}}_{n}^{- 1} {\hat{Ω}}_{n} {\hat{Λ}}_{n}^{- 1} {->}^{P} Ξ .$$

This assumption is not restrictive. Assumption (1-i) requires that \hat{θ}ₙ is \sqrt{n}-consistent and asymptotically normal with the asymptotic covariance matrix Ω. This usually holds under suitable regularity conditions in the context of Ordinary Least Squares (OLS) estimation. Assumption (1-ii) requires a consistent estimator \hat{Ω} for Ω, which may be computed as a HAC (heteroskedasticity and autocorrelation consistent) estimator. Assumption (1-iii) is in fact implied by Assumptions (1-i) and (1-ii); we state it as an assumption here for simplicity. For N(0,Ξ) in Assumption (1-iii), we also assume it can be well approximated by a simulated distribution Ψₙ^{u}=[Ψ_{1,n}^{u}, . . . , Ψ_{m,n}^{u}]^{T}.

The second assumption is stated as follows.

$${Ψ}_{n}^{u} {->}^{d} N ( 0 , Ξ )$$

conditional on the sample path with probability one.

There are various methods to obtain Ψₙ^{u}. One may generate Ψₙ^{u} by drawing samples from the pseudo random variable N (0, \hat{Ξ}ₙ) that is independent of the sample. Given the consistency of \hat{Ξ}ₙ, the simulated distribution would satisfy the second assumption. One may also approximate N (0, Ξ) by a proper bootstrap method.

### Step-RC Test

In some embodiments, the systems, devices, media and methods described herein include a Step-RC method, or use of the same. To account for potential data snooping, control of a proper error measure is needed. A leading measure is FWER=P[reject at least one true hypothesis], i.e., probability of rejecting at least one true hypothesis. The Step-RC method is able to identify many models that significantly deviate from the null hypotheses while controlling the FWER asymptotically.

Step-RC proceeds as follows. Let \hat{T}_{e,n}=\hat{θ}_{e,n}/\hat{σ}_{e,n} be the standardized test statistic for H₀^{e}. For 0<α<1 and for any subset K⊂{1, . . . , m} let \tilde{c}_{n,K}(α,1) be the α-th quantile of max{ψⱼ^{u}:jεK}, where {ψⱼ^{u}:jεK} are the simulated distributions that satisfy the second assumption. Moreover, a critical value ĉ_{n,K}(α,1) is set to ĉ_{n,K}(α,1)=max{\tilde{c}_{n,K}(α,1),0}. To implement Step-RC with asymptotic FWER control at α, we re-arrange \hat{T}_{e,n}'s in a descending order. A top model e would be rejected if \sqrt{n}\hat{T}_{e,n} is greater than ĉ_{n,A}_{₁}(1−α, 1), where A₁={1, . . . , m}. If none of the num hypotheses is rejected, the process stops; otherwise, we remove \hat{T}_{e,n} of the rejected models from the data. The index set of the remaining models is denoted as A₂ (A₂⊂A₁). The critical vales are then recalculated using the remaining data, giving rise to ĉ_{n,A}_{₂} (1−α, 1). A top model i would be rejected if \sqrt{n}\hat{T}_{i,n} is greater than ĉ_{n,A}_{₂} (1−α, 1). The procedure continues till no more models can be rejected.

### Step-SPA Test

In some embodiments, the systems, devices, media and methods described herein include a Step-SPA method, or use of the same. Step-SPA is an improvement over Step-RC with invoking the re-centering method. Let {aₙ} be a sequence of positive numbers such that lim_{n→∞}n^{-1/2} aₙ=0. For each e, define \hat{μ}_{e,n} as \hat{μ}_{e,n}=\hat{T}_{e,n}·1(\sqrt{n}\hat{T}_{e,n}≦−aₙ), in which 1(•) denotes the indicator function. For any subset K⊂{1, . . . , m} let \hat{q}_{n,K}(α, 1)=max{\tilde{q}_{n,K}(α, 1), 0} where \tilde{q}_{n,K}(α, 1) is the α-th quantile of max{ψⱼ^{u}+\sqrt{n}μ_{j,n}:jεK}. The procedure of Step-SPA is identical to that of Step-RC, except that the RC critical values ĉ_{n,K}(α, 1) are replaced by the SPA critical values \hat{q}_{n,K}(α, 1), which is more powerful than Step-RC under any power notion while still controlling the asymptotic FWER well.

The re-centering method works as follows. If a financial model θₖ, kεAⱼ is strictly less than zero, then one can show that \hat{θ}_{k,n} will not contribute to the null distribution of max_{eεA}_{ⱼ}{\sqrt{n}\hat{T}_{e,n}, 0}. By adding \sqrt{n}μ_{k,n} that diverges to negative infinity with probability one to the simulated distribution ψₖ^{u}, one can asymptotically remove the k-th model from consideration so as to lower the critical values and hence improve the power of the test.

Note that the Step-SPA test works as long as aₙ satisfies that lim_{n→∞}aₙ=∞ and that lim_{n→∞}n^{-1/2}aₙ=0. In some embodiments, aₙ can be chosen as aₙ=\sqrt{2 (log log n)}. In some embodiments, aₙ can be set as aₙ=\sqrt{log n}. Various equations can be embodied to set aₙ, as long as the required conditions at

$${lim}_{n -> ∞}$$

are met.

### Step-RC(k) Test

In some embodiments, the systems, devices, media and methods described herein include a multiple hypothesis Step-RC(k) test, or use of the same. When the number of hypotheses is large, the control of only one false rejection becomes a stringent criterion such that the resulting test has a limited ability to identify false hypotheses in finite samples. The test power may be increased by allowing for more than one false rejection. That is, the FWER control is relaxed to the FWER(k) control: FWER(k)=P[reject at least k true hypotheses], i.e., probability of rejecting at least k true hypotheses. Clearly, when k=1, this measure reduces to the FWER given in the Step-RC method. Step-RC(k) is a test that achieves the asymptotic control of the FWER(k) and also an improvement of the original Step-RC. The procedure of Step-RC(k) is described below. Let Y≡{ⱼ|j=1, . . . , J} be a collection of real numbers. Then for k≦J, k−max{Y} denotes the k-th largest value of Y. For example, if the elements in Y are ordered as y₍₁₎≧ . . . ≧y_{(J)}, then k-max{Y}=y₍ₖ₎. For any subset K⊂{1, . . . , m}, let ĉ_{n,K}(α,k)=max{c_{n,K}(α,k), 0} where c_{n,K}(α,k) is the α-th quantile of k-max{ψⱼ^{u}:jεK}.

In various embodiments, the algorithm of Step-RC(k) is as follows.
(a) Re-arrange \hat{T}_{e,n} in a descending order.
(b) Let A₁={1, . . . m} and \hat{d}_{n,A}_{₁}(1−α,k)=ĉ_{n,A}_{₁}(1−α,k). If max{\sqrt{n}\hat{T}_{e,n}:eεA₁}≦\hat{d}_{n,A}_{₁}(1−α,k), then accept all hypotheses and stop; otherwise, reject H₀^{e} if \sqrt{n}\hat{T}_{e,n}>\hat{d}_{n,A}_{₁}(1−α,k) and continue.
(c) Let R₂ be the collection of the indices e of the rejected hypotheses H₀^{e} in the previous step, and let A₂ be the collection of the indices of the remaining hypotheses. If |R₂|<k, then stop; otherwise, let \hat{d}_{n,A}_{₂}(1−α,k)=max_{I⊂R}_{₂}_{,|I|=k-1}{ĉ_{n,K}(1−α,k):K=A₂U∪I}. Reject H₀^{e} with eεA₂ such that \sqrt{n}\hat{T}_{e,n}>\hat{d}_{n,A}_{₂} (1−α,k). If there is no further rejection, stop; otherwise, go to next step.
(d) Repeat the previous step (with R₂ and A₂ replaced by Rⱼ and A₁, j≧3) till there is no further rejection.

Note that when k>1, the rejected hypotheses may still stay in the algorithm. The reason is that after the first step, it is possible that some true null hypotheses might have been rejected, but hopefully there are (at most) k−1 of them. Because it is not known which of the rejected hypotheses are true or false, all possible subsets of k−1 rejected hypotheses are considered in determining the critical values. Once the FWER(k) is controlled at each step, the stepwise procedure would also control the FWER(k). It can also be verified that the critical values in the last step of Step-RC(k) are no greater than that of Step-RC. As such, all models rejected by Step-RC will also be rejected by Step-RC(k), but not conversely.

Note also that in some embodiments the critical value may be \tilde{c}_{n,K}(α,k) rather than \tilde{c}_{n,K}(α,k). A drawback of such embodiments is that some hypotheses with non-positive statistics may be rejected, because \tilde{c}_{n,K}(α,k) may be strictly negative with a positive probability. This is considered an undesirable property because a negative statistic should not be viewed as an evidence for an alternative hypothesis. In contrast, the Step-RC(k) algorithm described herein is based on ĉ_{n,K}(α,k) and hence can never reject any hypothesis with a non-positive statistic.

### Step-SPA(k) Test

In some embodiments, the systems, devices, media and methods described herein include a multiple hypothesis Step-SPA(k) method, or use of the same. Step-SPA(k) extends Step-SPA to achieve the asymptotic control of the FWER(k). Step-SPA(k) is also an improvement of Step-RC(k) because it avoids the least favorable configuration (LFC) by invoking the re-centering method.

For any subset K⊂{1, . . . , m}, let \hat{q}_{n,K}(α,k)=max{\tilde{q}_{n,K}(α,k)} where \tilde{q}_{n,K}(α,k) is the α-th quantile of k-max{ψⱼ^{u}+\sqrt{n}\hat{μ}ⱼ:jεK}. In various embodiments, the algorithm of Step-SPA(k) is stated below.
(a) Re-arrange \hat{T}_{e,n} in a descending order.
(b) Let A₁={1, . . . m} and ŵ_{n,A}_{₁}(1−α,k)=\hat{q}_{n,A}_{₁}(1−α,k). If max{\sqrt{n}\hat{T}_{e,n}:eεA₁}≦ŵ_{n,A}_{₁}(1−α,k), then accept all hypotheses and stop; otherwise, reject H₀^{e} if \sqrt{n}\hat{T}_{e,n}>ŵ_{n,A}_{₁}(1−α,k) and continue.
(c) Let R₂ be the collection of the indices e of the rejected hypotheses H₀^{e} in the previous step, and let A₂ be the collection of the indices of the remaining hypotheses. If |R₂|<k, then stop; otherwise, let ŵ_{n,A}_{₂}(1−α,k)=max_{I⊂R}_{₂}_{,|I|=k-1}{\hat{q}_{n,K}(1−α,k):K=A₂∪I}. Reject H₀^{e} with eεA₂ such that \sqrt{n}\hat{T}_{e,n}>ŵ_{n,A}_{₂}(1−α,k). If there is no further rejection, stop; otherwise, go to next step.
(d) Repeat the previous step (with R₂ and A₂ replaced by Rⱼ and Aⱼ, j≧3) till there is no further rejection.

Clearly, Step-SPA(k) reduces to Step-SPA when k=1. It is straightforward to see that ŵ_{n,K}(1−α,k) satisfies the monotonicity requirement because by construction, for any K₁⊂K₂, ŵ_{n,K}_{₁}(α,k)≦ŵ_{n,K}_{₂}(α,k). Let I(P) be the set of the indices of the true null hypotheses. The algorithm in [0045] satisfies the size control as follows: lim_{n→∞}P[k-max{\sqrt{n}\hat{T}_{e,n}:eεI(P)}>\hat{q}_{n,I(P)}(1−α,k)]≦α. In other words, the Step-SPA(k) test has the asymptotic FWER(k) control. Note that if θₑ>0, then \sqrt{n}\hat{T}_{e,n}→∞ in probability, whereas the critical value \hat{q}_{n,A}_{₁}(1−α,k) is bounded in probability. Thus, any superior model will be rejected in the first step with probability approaching one. This establishes the consistency of the Step-SPA(k) test.

### False-Discovery-Proportion Control Algorithm

In some embodiments, the systems, devices, media and methods described herein include a false discovery proportion, or use of the same. A drawback of a test that controls the FWER(k) is that the choice of k does not depend on data. For the cases that a large number of false hypotheses are present, a test that allows for a fixed, small number of false rejections, e.g. FWER(k) with a small k, may still be conservative. This problem can be circumvented by controlling a different error rate, such as False Discovery Proportion (FDP). Note that FDP is defined as the ratio of the number of false rejections (F) over the number of total rejections (R):

$$FDP = \{ \begin{matrix}\frac{F}{R} , if R > 0 \\ 0 , if R - 0\end{matrix} .$$

For a given number 0<γ<1, a multiple testing procedure is said to asymptotically control the FDP at the significance level α if lim sup P[FDP>γ]≦α.

The following non-limiting examples illustrate the relation between FWER(k) and FDP. Letting γ=0.1 and α=5%, suppose that there are 10 superior models in the database. Assuming that the procedure is consistent in that all superior models will be rejected in the first step with probability approaching one, FDP will then be equal to

$$\frac{F}{F + 10}$$

which would be larger than 0.1 if, and only if, F≧2. In this case, the FDP control is asymptotically equivalent to the FWER(2) control. If there are more, say 100, superior models, then FDP control with γ=0.1 would be equivalent to FWER(11). In view of these examples, the FDP control may be interpreted as a data dependent FWER(k) control, in the sense that k depends on the underlying data generating process.

A procedure that controls the FDP at the level α may be constructed from a procedure that controls the FWER(k) with k fixed. In various embodiments, the FDP-SPA algorithm below is based on Step-SPA(k).
(a) Set k=1 and a γ value between 0 and 1.
(b) Apply the Step-SPA(k) test with α. Let Nₖ denote the number of the rejected hypotheses by the Step-SPA(k) test.
(c) If

$${N}_{k} < \frac{k}{γ} - 1 ,$$

stop and reject all hypotheses rejected by the Step-SPA(k) test; otherwise, set k=k+1 and return to Step (b).

In this algorithm, the stopping rule is

$${N}_{k} < \frac{k}{γ} - 1.$$

Among Nₖ rejected models, the probability of having k−1 or less false rejections is greater than or equal to 1−α. If k is incremented to k+1, it is very likely to get one more false rejection, but no true rejection. Then, the FDP becomes

$$\frac{k}{{N}_{k} + 1} .$$

### When

$$\frac{k}{{N}_{k} + 1} \leq γ ,$$

the FDP can still be controlled well if the Step-SPA(k+1) test is continually implemented. In other words, the procedure should be stopped when

$$\frac{k}{{N}_{k} + 1} > γ ,$$

which is equivalent to

$${N}_{k} < \frac{k}{γ} - 1.$$

### Computer System Implementation

In some embodiments, the systems, devices, media and methods described herein include a computing system to implement the financial model, the hypothesis tests, and/or the model rating and selection. The implementation can be based on software, hardware, or a combination of the same. In some cases, hardware implementation comprises an electronic component that can execute the statistical computations. Suitable electronic components include application specific integrated circuits, field-programmable gate arrays, graphical processing units, or a combination of the same.

FIG. 1 illustrates a non-limiting example environment for implementing model rating and selection, in accordance with at least one embodiment. In this example, one or more user devices 102 connect via a network 104 to a model testing server 106. In various embodiments, the user devices 102 may include any devices capable of connecting via a public network to model testing server 106, such as personal computers, smartphones, tablet computing devices, and the like. In an embodiment, network 104 may include any publicly accessible networks (such as the Internet, mobile and/or wireless networks), private network or any other networks. The user devices 102 may include applications such as web browsers capable of communicating with the model testing server 106, for example, via an interface provided by the model testing server 106. Such an interface may include an application programming interface (API) such as a web service interface, a graphical user interface (GUI), and the like.

The model testing server 106 may be implemented by one or more physical and/or logical computing devices or computer systems that collectively provide a model testing service. For example, in an embodiment, the model testing service may be configured provide a user interface for receiving input parameters and/or command from one or more users operating user devices, perform model rating and selection including identifying top performing models relative to a benchmark model, and display the results to the users in the user interface. In some embodiments, some or all aspects of the model testing service may be performed by an automated process with little or no user intervention.

In an embodiment, the model testing server 106 communicates with one or more local data stores/services 108 and/or with one or more remote data stores/services 110 via the network 104. The data stores/services 108 and 110 may be used by the model testing server 106 to retrieve and/or store data used and/or generated by the model testing server 106. The data stores/services 108 and 110 may include one or more databases, data storage devices (e.g., tape, hard disk, solid-state drive), data storage servers, data storage services, or the like. In various embodiments, data stored in and/or provided by data stores/services 108 and 110 may store parameters controlling aspects of the model testing methods implemented by the model testing server 106 and described herein, user-provided data, performance data and other data associated with models to be tested and benchmark model(s), the result of the model testing, and the like.

FIG. 2 illustrates non-limiting example components of a computing device used to implement the model rating and selection, in accordance with at least one embodiment. The computing device may include the model testing server 106 or user device 102 discussed in connection with FIG. 1. In some embodiments, the computing device includes many more components than those shown in FIG. 2. However, it is not necessary that all of these generally conventional components be shown in order to disclose an illustrative embodiment.

As shown in FIG. 2, computing device may include a network interface 202 for connecting to a network such as network 104 discussed in connection with FIG. 1. In various embodiments, the computing device includes one or more network interfaces 202 for communicating with one or more types of networks such as IEEE 802.11-based networks, cellular networks and the like.

In an embodiment, the computing device also includes one or more processing units 204, a memory 206, and an optional display 208, all interconnected along with the network interface 202 via a bus 210. The processing unit(s) 204 may be capable of executing one or more methods or routines stored in the memory 206. The display 208 may be configured to provide a graphical user interface to a user operating the computing device 200 for receiving user input, displaying output, and/or executing applications, such as a web browser application. Any display known in the art may be used for the display 208 including, but not limited to, a cathode ray tube, a liquid crystal display, a plasma screen, a touch screen, an LED screen, or an OLED display.

The memory 206 may generally comprise a random access memory (“RAM”), a read only memory (“ROM”), and/or a permanent mass storage device, such as a disk drive. The memory 206 may store program code for an operating system 212, a model testing routine 214 and other applications configured to perform other functionalities such as document processing, data management, multimedia development, entertainment and the like. In some embodiments, the computing device 200 may include logic or executable program, e.g., as part of the operating system 212, to control various components of the device 200. For example, the device may include logic for controlling input/output (I/O), data storage, network access (e.g., access to radio networks such as WLAN, Bluetooth, and cellular networks).

In some embodiments, the software components discussed above may be loaded into memory 206 using a drive mechanism (not shown) associated with a non-transient computer readable storage medium 218, such as a floppy disc, tape, DVD/CD-ROM drive, memory card, USB flash drive, solid state drive (SSD) or the like. In other embodiments, the software components may alternately be loaded via the network interface 202, rather than via a non-transient computer readable storage medium 218.

In some embodiments, the computing device 200 also communicates via bus 210 with one or more local or remote data stores or services (not shown) via the bus 210 or the network interface 202. The bus 210 may comprise a storage area network (“SAN”), a high-speed serial bus, and/or via other suitable communication technology. In some embodiments, such data stores or services may be integrated as part of the computing device 200.

FIG. 3 illustrates another non-limiting example environment for implementing multi-model testing, in accordance with at least one embodiment. In this example, an application 306 running on a user device 302 implement aspects of the model testing. The model testing application 306 may be similar to the model testing service provided by the model testing server 106 discussed in connection with FIG. 1. For example, in an embodiment, the model testing application 306 may be configured to provide a user interface for receiving input parameters and commands from a user, perform model rating and selection including identifying top performing models relative to a benchmark model, and display the results to the user in the user interface. In some embodiments, some or all aspects of the model testing service may be performed by an automated process with little or no user intervention.

In various embodiments, the user device 302 may be configured to retrieve and/or store model-testing related data from and/or to one or more local data stores or services 308 and/or remote data stores or services 310 via network 304. The data stores/services 308 and 310 may be similar to the data stores/services 108 and 110 discussed in connection with FIG. 1. The user device 302 may also communicate with other user devices, servers or computer systems (not shown) via network 304. In various embodiments, the user device 302 may also include other applications.

### Data Analysis Process

FIG. 4 illustrates a non-limiting example process for implementing model rating and selection, in accordance with at least one embodiment. Aspects of the process may be performed, for example, by the model testing server 106 discussed in connection with FIG. 1 or the user device 302 discussed in connection with FIG. 3. Some or all of the process (or any other processes described herein, or variations and/or combinations thereof) may be performed under the control of one or more computer/control systems configured with executable instructions and may be implemented as code (e.g., executable instructions, one or more computer programs or one or more applications) executing collectively on one or more processors, by hardware or combinations thereof. The code may be stored on a computer-readable storage medium, for example, in the form of a computer program comprising a plurality of instructions executable by one or more processors. The computer-readable storage medium may be non-transitory. The order in which the operations are described is not intended to be construed as a limitation, and any number of the described operations may be combined in any order and/or in parallel to implement the processes.

In an embodiment, process 400 includes receiving 402 a request to evaluate performance of a plurality of models according to a performance metric. Such a request may include a request to identify top-performing models or superior models from the plurality of models according to the performance metric. In some embodiments, the request may originate from a user device such as described in connection with FIG. 1. For example, a user may select, from web interface or a client application interface, a plurality of models from which superior models are to be identified.

In various embodiments, superior or top-performing models are chosen by comparing the performance of the models against some benchmark models according to one or more performance metrics. In various embodiments, performance metrics may include absolute performance metrics such as mean excess return (e.g. on a monthly basis), Sharpe ratio, GIS MPPM and the like and relative performance metrics such as alpha (abnormal return estimated by benchmarking factor models such as CAPM, Fama-French-Carhart 4-factor model, and Fung-Hsieh 7-factor model), t-ratio of alpha, and the like.

In various embodiments, a benchmark may be fixed or random. For example, to determine whether a trading rule yields a positive CAPM alpha, the benchmark may be fixed at the risk-free rate or the buy-and-hold rate of return. For another example, to determine whether a hedge fund beats the performance of a specific investment, such as a stock market index, the benchmark may be the return of the stock market index.

In an embodiment, the process includes obtaining 404 performance data associated with the plurality of models. In some embodiments, some or all of such information may be provided (e.g., uploaded) by an entity implementing the model testing service, a user, a third-party data provider such as the Hedge Fund Research (HFR) database, or the like. In some embodiments, performance data for one or more benchmark models may be obtained as well.

In an embodiment, the process includes identifying 406 one or more superior model(s) from the plurality of models relative to a benchmark model according to a performance metric while reducing data snooping bias and improving the test power. In an embodiment, a hypothesis such as a null hypothesis is generated for each of the models based on a benchmark performance metric such as discussed above. These hypotheses may be tested to determine whether they can be rejected or accepted with a predetermined level of significance. Typically, when a hypothesis is rejected, the corresponding model is determined to be a superior model. To identify superior models, in some embodiments, a step-wise approach may be used where one or more superior models may be identified from the plurality of models at each step or iteration.

FIG. 5 illustrates an example for implementing model rating and selection, in accordance with at least one embodiment. In an embodiment, the process includes determining 502 a performance metric and a plurality of models to evaluate. Such determination 502 may be based on configurable information such as user defined parameter. In an embodiment, a hypothesis (typically a null hypothesis) may be formed 504 for each of the plurality of models based at least in part on the performance metric. In particular, the performance measure of a benchmark model may be used to form a null hypothesis. For each hypothesis, a corresponding test statistic may be obtained 506 to measure the performance of the corresponding model relative to the benchmark model.

In an embodiment, the process includes obtaining 508, under pre-determined assumptions, one or more cross-sectional empirical distributions while controlling FWER(k). The pre-determined assumptions may include the value of k in FWER(k), bootstrapping parameters, false discovery proportion, level of significance, re-centering conditions, and any other parameters to be used during the testing of the models. Such pre-determined assumptions may be provided or pre-configured by a user (e.g., via a user interface), an administrator or the like.

In various embodiments, the one or more cross-sectional empirical distributions may be generated using bootstrapping techniques, Monte Carlo simulation or other suitable estimation methods. Such empirical distribution is cross-sectional since the distribution encompasses data associated with multiple models and hence hypotheses. During the initial iteration, typically only one cross-sectional empirical distribution is generated (e.g., by bootstrapping) based on the datasets associated with all the available hypothesis or models. In a subsequent iteration, more than one empirical distribution may be obtained, each corresponding to a subset of the initial datasets of hypotheses or models. For example, assuming there are m hypotheses (corresponding to m models) to start with. During the initial iteration at step 508, an empirical distribution is generated based on the datasets associated with all m hypotheses. Suppose during the initial iteration, n of the m hypotheses are rejected (where n<m), then during the second iteration, one or more empirical distributions may be generated based at least in part on the datasets associated with the remaining m-n hypotheses that are not rejected during the initial iteration.

In some embodiments, the data resulting from calculations performed for previous iterations may be stored and/or used for subsequent iterations. For example, when an initial empirical distribution is generated for datasets associated with all models via bootstrapping, the bootstrapping data may be saved and used to generate subsequent empirical distributions based on datasets associated with a subset of the initial set of models.

FIG. 6 illustrates a non-limiting example process implementing model rating and selection, in accordance with at least one embodiment. In particular, it illustrates an example implementation of the FDP control discussed above. In an embodiment, the process includes determining 602 an FDP threshold (e.g., γ=0.1) and a significance level (e.g., α=5%). In some embodiments, either or both of FDP threshold and FDP significance level may be user-defined (e.g., via a user interface). In an initial iteration, a counter k may be initiated 604 to be an initial value such as 1. Subsequently, the process includes obtaining Nₖ rejected models as a result of performing hypothesis testing of a given set of models while controlling FWER(k) to be equal to the given significance level. In some embodiments, the hypothesis testing is similar to the process discussed above in connection with FIG. 5. In some cases, the hypothesis testing uses Step-RC, Step-RC(k), Step-SPA, Step-SPA(k), or a combination of the same.

In an embodiment, the process includes determining whether the total number of rejected models. Then, the process includes indicating that the Nₖ rejected models should be rejected and are considered superior relative to the given benchmark model. In some embodiments, k may be incremented by 1. In other words, set k=k+1. In other embodiments, k may be incremented by an amount other than 1 (e.g., setting k=k+2). Subsequently, the process includes iterating back to step 606 to perform hypothesis testing while controlling FWER(k) where k has been incremented.

Step-SPA(k) Test with Controlling False Discovery Proportion

In some embodiments, a system comprising a Step-SPA(k) test and a false discovery proportion control is used to rate and select financial models. An embodied algorithm is described below. Assuming the system acquires the data of m financial models, each of which contains n data observations. The parameters of the algorithm include: a threshold γ of false discovery proportion, and a significance level α. The threshold and/or the significance level can be designated by a user, or by an automatic method that analyzes empirically a portion of historical financial and/or non-financial data. Referring to FIG. 7, the algorithm is described below. In step 702, the algorithm initializes a counter to be one and initializes a set of rejected financial models to be an empty set. In step 704, the algorithm computes a test statistic for each financial model; the test statistic comprises a performance measure of the financial model. The performance measure may be static all the time, or can be dynamically adjusted based on the set of rejected financial models and/or the counter. In step 706, the system computes a critical value derived from the significance level α and one or more subsets of the financial models, wherein the subsets of the financial models are defined by the counter and the current set of rejected financial models. In step 708, the system rejects a financial model whose test statistic is greater than the critical value. Sometimes, there may be no financial model being rejected at this step. In step 710, the stepwise-superior-predictive-ability test is terminated if the number of rejected financial models is smaller than one or more criteria. In some cases, the criteria correspond to the value of the current counter. Alternative criteria may be another quantity derived by the counter, the significance level, and/or the generalized family-wise error rate. In step 710, when the criteria are not met, the counter is incremented by 1, and the algorithm repeats back to the step 706. Finally, step 714 presents all rejected financial models as the selected superior models.

The mathematical descriptions of an embodiment are summarized below. A counter k was initialized as k=1. Then, the significance level α was used to iterate the Step-SPA(k) test underlying this algorithm. The analysis steps are summarized below.
(a) Initialize k=1.
(b) Compute a test statistic \hat{T}_{e,n} for each model e. Re-index the financial models such that \hat{T}_{e,n} were in a descending order; i.e., \hat{T}_{1,n}≧\hat{T}_{2,n}≧ . . . ≧\hat{T}_{m,n}.
(c) Use all the financial models to compute a critical value ŵₙ(1−α,k)=\hat{q}ₙ(1−α,k). If max{\sqrt{n}\hat{T}_{e,n}}≦ŵₙ(1−α,k), then accept all hypotheses and jump to step (f); otherwise, reject the e-th model if \sqrt{n}\hat{T}_{e,n}>ŵₙ(1−α,k) and continue.
(d) Let R be the collection of the indices e of the rejected financial models, and let A be the collection of the indices of the remaining non-rejected hypotheses. If the number of rejected models was smaller than k (i.e., |R|<k), then jump to step (f); otherwise, enumerate all the subsets of R with size k−1, make a union of each subset and the set A, and compute a critical value ŵₙ(1−α,k) of all the unions (i.e., let ŵₙ(1−α,k)=maX_{I⊂R,|I|=k-1}{\hat{q}_{n,K}(1−α,k):K=A∪I}).
(e) If max{\sqrt{n}\hat{T}_{e,n}}≦ŵₙ(1−α,k), then accept all hypotheses and jump to step (f); otherwise, reject the e-th model if \sqrt{n}\hat{T}_{e,n}>ŵₙ(1−α,k) and go back to step (d).
(f) Let Nₖ denote the number of the rejected hypotheses.
(g) If

$${N}_{k} < \frac{k}{γ} - 1 ,$$

stop and reject all hypotheses indicated by R; otherwise, set k=k+1 and return to step (c).
(h) Present the superior models corresponding to the hypotheses indicated by R.

### Digital Processing Device

In some embodiments, the platforms, systems, software applications, media, and methods described herein include a digital processing device, or use of the same. In further embodiments, the digital processing device includes one or more hardware central processing units (CPU) that carry out the device's functions. In still further embodiments, the digital processing device further comprises an operating system configured to perform executable instructions. In some embodiments, the digital processing device is optionally connected a computer network. In further embodiments, the digital processing device is optionally connected to the Internet such that it accesses the World Wide Web. In still further embodiments, the digital processing device is optionally connected to a cloud computing infrastructure. In other embodiments, the digital processing device is optionally connected to an intranet. In other embodiments, the digital processing device is optionally connected to a data storage device.

In accordance with the description herein, suitable digital processing devices include, by way of non-limiting examples, server computers, desktop computers, laptop computers, notebook computers, sub-notebook computers, netbook computers, netpad computers, set-top computers, handheld computers, Internet appliances, mobile smartphones, tablet computers, personal digital assistants, video game consoles, and vehicles. Those of skill in the art will recognize that many smartphones are suitable for use in the system described herein. Those of skill in the art will also recognize that select televisions, video players, and digital music players with optional computer network connectivity are suitable for use in the system described herein. Suitable tablet computers include those with booklet, slate, and convertible configurations, known to those of skill in the art.

In some embodiments, the digital processing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux®. In some embodiments, the operating system is provided by cloud computing. Those of skill in the art will also recognize that suitable mobile smart phone operating systems include, by way of non-limiting examples, Nokia®Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

In some embodiments, the device includes a storage and/or memory device. The storage and/or memory device is one or more physical apparatuses used to store data or programs on a temporary or permanent basis. In some embodiments, the device is volatile memory and requires power to maintain stored information. In some embodiments, the device is non-volatile memory and retains stored information when the digital processing device is not powered. In further embodiments, the non-volatile memory comprises flash memory. In some embodiments, the non-volatile memory comprises dynamic random-access memory (DRAM). In some embodiments, the non-volatile memory comprises ferroelectric random access memory (FRAM). In some embodiments, the non-volatile memory comprises phase-change random access memory (PRAM). In other embodiments, the device is a storage device including, by way of non-limiting examples, CD-ROMs, DVDs, flash memory devices, magnetic disk drives, magnetic tapes drives, optical disk drives, and cloud computing based storage. In further embodiments, the storage and/or memory device is a combination of devices such as those disclosed herein.

In some embodiments, the digital processing device includes a display to send visual information to a user. In some embodiments, the display is a cathode ray tube (CRT). In some embodiments, the display is a liquid crystal display (LCD). In further embodiments, the display is a thin film transistor liquid crystal display (TFT-LCD). In some embodiments, the display is an organic light emitting diode (OLED) display. In various further embodiments, on OLED display is a passive-matrix OLED (PMOLED) or active-matrix OLED (AMOLED) display. In some embodiments, the display is a plasma display. In other embodiments, the display is a video projector. In still further embodiments, the display is a combination of devices such as those disclosed herein.

In some embodiments, the digital processing device includes an input device to receive information from a user. In some embodiments, the input device is a keyboard. In some embodiments, the input device is a pointing device including, by way of non-limiting examples, a mouse, trackball, track pad, joystick, game controller, or stylus. In some embodiments, the input device is a touch screen or a multi-touch screen. In other embodiments, the input device is a microphone to capture voice or other sound input. In other embodiments, the input device is a video camera to capture motion or visual input. In still further embodiments, the input device is a combination of devices such as those disclosed herein.

### Non-Transitory Computer Readable Storage Medium

In some embodiments, the platforms, systems, software applications, media, and methods disclosed herein include one or more non-transitory computer readable storage media encoded with a program including instructions executable by the operating system of an optionally networked digital processing device. In further embodiments, a computer readable storage medium is a tangible component of a digital processing device. In still further embodiments, a computer readable storage medium is optionally removable from a digital processing device. In some embodiments, a computer readable storage medium includes, by way of non-limiting examples, CD-ROMs, DVDs, flash memory devices, solid state memory, magnetic disk drives, magnetic tape drives, optical disk drives, cloud computing systems and services, and the like. In some cases, the program and instructions are permanently, substantially permanently, semi-permanently, or non-transitorily encoded on the media.

### Web Application

In some embodiments, a computer program includes a web application. In light of the disclosure provided herein, those of skill in the art will recognize that a web application, in various embodiments, utilizes one or more software frameworks and one or more database systems. In some embodiments, a web application is created upon a software framework such as Microsoft®.NET or Ruby on Rails (RoR). In some embodiments, a web application utilizes one or more database systems including, by way of non-limiting examples, relational, non-relational, object oriented, associative, and XML database systems. In further embodiments, suitable relational database systems include, by way of non-limiting examples, Microsoft® SQL Server, mySQL™, and Oracle®. Those of skill in the art will also recognize that a web application, in various embodiments, is written in one or more versions of one or more languages. A web application may be written in one or more markup languages, presentation definition languages, client-side scripting languages, server-side coding languages, database query languages, or combinations thereof. In some embodiments, a web application is written to some extent in a markup language such as Hypertext Markup Language (HTML), Extensible Hypertext Markup Language (XHTML), or eXtensible Markup Language (XML). In some embodiments, a web application is written to some extent in a presentation definition language such as Cascading Style Sheets (CSS). In some embodiments, a web application is written to some extent in a client-side scripting language such as Asynchronous Javascript and XML (AJAX), Flash® Actionscript, Javascript, or Silverlight®. In some embodiments, a web application is written to some extent in a server-side coding language such as Active Server Pages (ASP), ColdFusion®, Perl, Java™, JavaServer Pages (JSP), Hypertext Preprocessor (PHP), Python™, Ruby, Tcl, Smalltalk, WebDNA®, or Groovy. In some embodiments, a web application is written to some extent in a database query language such as Structured Query Language (SQL). In some embodiments, a web application integrates enterprise server products such as IBM® Lotus Domino®. In some embodiments, a web application includes a media player element. In various further embodiments, a media player element utilizes one or more of many suitable multimedia technologies including, by way of non-limiting examples, Adobe® Flash®, HTML 5, Apple® QuickTime®, Microsoft® Silverlight®, Java™, and Unity®.

### Standalone Application

In some embodiments, a computer program includes a standalone application, which is a program that is run as an independent computer process, not an add-on to an existing process, e.g., not a plug-in. Those of skill in the art will recognize that standalone applications are often compiled. A compiler is a computer program(s) that transforms source code written in a programming language into binary object code such as assembly language or machine code. Suitable compiled programming languages include, by way of non-limiting examples, C, C++, Objective-C, COBOL, Delphi, Eiffel, Java™, Lisp, Python™, Visual Basic, and VB .NET, or combinations thereof. Compilation is often performed, at least in part, to create an executable program. In some embodiments, a computer program includes one or more executable complied applications.

### Software Modules

In some embodiments, the platforms, systems, software applications, media, and methods disclosed herein include software, server, and/or database modules, or use of the same. In view of the disclosure provided herein, software modules are created by techniques known to those of skill in the art using known machines, software, and languages. The software modules disclosed herein are implemented in a multitude of ways. In various embodiments, a software module comprises a file, a section of code, a programming object, a programming structure, or combinations thereof. In further various embodiments, a software module comprises a plurality of files, a plurality of sections of code, a plurality of programming objects, a plurality of programming structures, or combinations thereof. In various embodiments, the one or more software modules comprise, by way of non-limiting examples, a web application, a mobile application, and a standalone application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on cloud computing platforms. In some embodiments, software modules are hosted on one or more machines in one location. In other embodiments, software modules are hosted on one or more machines in more than one location.

### Databases

In some embodiments, the platforms, systems, software applications, media, and methods disclosed herein include one or more databases, or use of the same. In view of the disclosure provided herein, those of skill in the art will recognize that many databases are suitable for storage and retrieval of financial data and non-financial data. In various embodiments, suitable databases include, by way of non-limiting examples, relational databases, non-relational databases, object oriented databases, object databases, entity-relationship model databases, associative databases, and XML databases. In some embodiments, a database is internet-based. In further embodiments, a database is web-based. In still further embodiments, a database is cloud computing-based. In other embodiments, a database is based on one or more local computer storage devices.

### EXAMPLES

The following illustrative examples are representative of embodiments of the software applications, systems, and methods described herein and are not meant to be limiting in any way. While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention.

### Example 1

### Simulation of Step-SPA(k)

This example presents simulation results of the Step-SPA(k) test with k=3. For comparison, Step-RC, Step-RC(3), and Step-SPA were also computed. In the simulations, two random variables were considered: N(μ, 1) and t(4)/\sqrt{2}+μ, where the latter also had variance 1. For each variable, there were S models (with different pt values), each with n i.i.d. ovservations. S was set as 100, 200, 500 and n as 100, 200, 500. This setting allowed examination of how different tests perform when the number of models is less than, equal to, or greater than the number of observations. These S models may be uncorrelated (ρ=0) or correlated (ρ=0.2, 0.4). For financial model e, we computed the standardized Step-SPA(3) statistic \hat{T}_{e,n}, with the re-centering parameter aₙ=\sqrt{2 log(log n)}. The number of bootstraps for computing the critical values was B=1000. The number of replications for each simulation was B=1000. All the tests were based on 5% significance level.

Regarding the bootstrap used herein, ψₙ^{u} was defined as was \sqrt{n}\hat{Λ}⁻¹(\hat{θ}ₙ^{b}−\hat{θ}ₙ), where \hat{θ}ₙ^{b} was calculated from each bootstrap sample formed by n random draws with replacement form the original data. Another approach was to calculate the standardized test statistic based on the bootstrap samples: \sqrt{n}(\hat{T}ₙ^{b}−\hat{T}ₙ), where \hat{T}ₙ=\hat{Λ}⁻¹\hat{θ}ₙ and \hat{T}ₙ^{b}=(\hat{Λ}^{b})⁻¹\hat{θ}ₙ^{b}. To save computational time, the first method was adopted in the simulations. However, the second method could be used in the empirical study because it may be preferable to calculate \hat{Λ}^{b} from the bootstrap sample in practice.

The control of FWER(3) under LFC is first studied by setting all models with μ=0. Here are the FWER(3) results of Step-RC(3) and Step-SPA(3) in Tables 1 and 2 for models generated from, respectively, normal and t(4) variables. It can be seen that, for models generated from normal random variables with ρ=0, these two tests had good control of the FWER(3) when the number of models S was less than or equal to the number of observations n, yet they tended to over-reject when S>n. The control of the FWER(3) was adversely affected by model correlation (ρ=0.4). For models generated from t(4) variables which had fatter tails than N (0,1), both tests had better control of the FWER(3). Although these tests may under-reject when ρ=0, their FWER(3) were quite close to 5% when models were correlated.

TABLE 1
Control of FWER(3) under LFC: Normal random variables with μ = 0

| | S = 100 | | | S = 200 | | | S = 500 | | |
|---|---|---|---|---|---|---|---|---|---|
| | n = 100 | n = 200 | n = 500 | n = 100 | n = 200 | n = 500 | n = 100 | n = 200 | n = 500 |
| | Model Correlation ρ = 0 | | | | | | | | |
| Step-RC(3) | 4.5 | 5.4 | 4.9 | 5.4 | 4.2 | 5.2 | 5.5 | 6.7 | 5.5 |
| Step-SPA(3) | 5.5 | 6.0 | 5.4 | 6.0 | 4.7 | 5.5 | 5.8 | 7.2 | 6.1 |
| | Model Correlation ρ = 0.2 | | | | | | | | |
| Step-RC(3) | 5.0 | 4.9 | 5.5 | 6.2 | 5.5 | 5.3 | 8.2 | 5.8 | 4.5 |
| Step-SPA(3) | 5.0 | 4.9 | 5.5 | 6.2 | 5.5 | 5.3 | 8.2 | 5.9 | 4.5 |
| | Model Correlation ρ = 0.4 | | | | | | | | |
| Step-RC(3) | 6.5 | 6.2 | 4.6 | 6.3 | 7.0 | 5.7 | 6.7 | 5.1 | 7.0 |
| Step-SPA(3) | 6.5 | 6.2 | 4.6 | 6.3 | 7.0 | 5.7 | 6.7 | 5.1 | 7.0 |

Note:
S is the number of models,
n is the number of observations, and
ρ is the correlation coefficient between models.
Empirical FWER(3)'s are expressed in percentages;
the nominal significance level is α = 5%.

TABLE 2
Control of FWER(3) under LFC: t(4) random variables with μ = 0

| | S = 100 | | | S = 200 | | | S = 500 | | |
|---|---|---|---|---|---|---|---|---|---|
| | n = 100 | n = 200 | n = 500 | n = 100 | n = 200 | n = 500 | n = 100 | n = 200 | n = 500 |
| | Model Correlation ρ = 0 | | | | | | | | |
| Step-RC(3) | 3.5 | 2.9 | 2.9 | 2.9 | 3.1 | 2.4 | 4.2 | 1.9 | 3.6 |
| Step-SPA(3) | 4.0 | 3.3 | 3.3 | 3.2 | 3.3 | 2.8 | 3.2 | 2.0 | 3.6 |
| | Model Correlation ρ = 0.2 | | | | | | | | |
| bStep-RC(3) | 4.9 | 4.6 | 4.7 | 4.2 | 5.6 | 4.6 | 4.6 | 4.2 | 4.4 |
| Step-SPA(3) | 5.0 | 4.0 | 4.7 | 4.2 | 5.6 | 4.6 | 4.6 | 4.2 | 4.4 |
| | Model Correlation ρ = 0.4 | | | | | | | | |
| Step-RC(3) | 4.8 | 4.3 | 5.2 | 5.1 | 5.9 | 4.7 | 5.1 | 4.8 | 4.2 |
| Step-SPA(3) | 4.8 | 4.3 | 5.2 | 5.1 | 5.9 | 4.7 | 5.1 | 4.8 | 4.2 |

Note:
S is the number of models,
n is the number of observations, and
ρ is the correlation coefficient between models.
Empirical FWER(3)'s are expressed in percentages;
the nominal significance level is α = 5%.

In the power simulations, the models were generated as follows. There were 10% of S models with μ=0, 20% with μ>0 (i.e., μ distributed evenly between 0.15 and 0.2), and 70% with μ<0 (i.e., μ distributed evenly between 0 and 3). For example, for S=100, there were 20 positive means (0.1525, 0.155, 0.1575, . . . , 0.201), 10 zero means, and 70 negative means (−3/70, −6/70, . . . , −3). The SPA-type tests, by construction, have better power than RC-type tests when poor financial models are present. A larger portion of models with negative means were generated so as to make the difference between the performance of Step-RC(3) and Step-SPA(3) more obvious. The average power, global power, and minimum power were simulated. The average powers (the proportion of true rejections) of these tests are summarized in Tables 3 and 4. For models generated from, respectively normal and t(4) variables. The tables also report the corresponding FWER for Step-RC and Step-SPA and FWER(3) for Step-RC(3) and Step-SPA(3), presented in parentheses in the tables.

The results are described below. First, with reference to Tables 3 and 4, all the tests controlled the FWER or the FWER(3) well. Second, Step-SPA(3) and Step-RC(3) had much higher average power than the corresponding Step-SPA and Step-RC tests. This confirms that a test would have better power if it controls the FWER(k) instead of the FWER. Third, STEP-SPA(3) outperformed Step-RC(3) remarkably in all experiments considered. Fourth, for normal random variables, the average power of Step-SPA(3) was high, as long as the number of observations was greater than or equal to the number of models. Finally, model correlation had an adverse effect on the average powers of Step-SPA(3) and Step-RC(3). These observations also held for models generated from t(4). In summary, when the number of observations is large relative to the number of models, it is preferable to consider Step-SPA(3).

TABLE 3
Average power performance and control of FWER: Normal random variables.

| | S = 100 | | | S = 200 | | | S = 500 | | |
|---|---|---|---|---|---|---|---|---|---|
| | n = 100 | n = 200 | n = 500 | n = 100 | n = 200 | n = 500 | n = 100 | n = 200 | n = 500 |
| | Model Correlation ρ = 0 | | | | | | | | |
| Step-RC | 7.4 | 22.9 | 73.0 | 5.4 | 17.3 | 66.7 | 3.3 | 12.1 | 58.1 |
| (FWER) | (1.0) | (0.6) | (0.4) | (0.9) | (0.6) | (0.8) | (1.2) | (1.1) | (0.7) |
| Step-SPA | 12.9 | 33.4 | 52.7 | 9.3 | 26.0 | 77.0 | 6.7 | 18.7 | 68.6 |
| (FWER) | (2.9) | (1.9) | (1.6) | (1.8) | (1.6) | (2.0) | (3.8) | (2.5) | (2.4) |
| Step-RC(3) | 25.8 | 54.3 | 93.2 | 18.6 | 43.9 | 89.8 | 11.7 | 32.5 | 83.1 |
| (FWER(3)) | (0.0) | (0.0) | (0.0) | (0.0) | (0.0) | (0.1) | (0.0) | (0.0) | (0.0) |
| Step-SPA(3) | 43.3 | 75.9 | 98.5 | 32.8 | 64.9 | 97.2 | 21.0 | 50.1 | 94.1 |
| (FWER (3)) | (0.5) | (1.0) | (1.8) | (0.3) | (0.4) | (3.3) | (3.8) | (0.3) | (2.8) |
| | Model Correlation ρ = 0.2 | | | | | | | | |
| Step-RC | 8.1 | 24.2 | 75.1 | 6.2 | 18.4 | 69.0 | 3.8 | 13.1 | 59.7 |
| (FWER) | (0.8) | (0.7) | (0.3) | (0.8) | (0.7) | (0.7) | (1.0) | (0.5) | (0.8) |
| Step-SPA | 13.3 | 25.6 | 84.2 | 10.0 | 26.8 | 78.4 | 6.3 | 19.4 | 69.9 |
| (FWER) | (2.8) | (2.0) | (1.0) | (1.9) | (2.0) | (1.7) | (2.7) | (1.1) | (1.9) |
| Step-RC(3) | 21.4 | 48.0 | 91.0 | 15.8 | 37.5 | 86.4 | 10.0 | 27.4 | 79.1 |
| (FWER(3)) | (0.2) | (0.1) | (0.1) | (0.1) | (0.1) | (0.0) | (0.0) | (0.4) | (0.2) |
| Step-SPA(3) | 36.8 | 69.3 | 97.8 | 27.6 | 56.6 | 95.7 | 17.7 | 42.5 | 91.3 |
| (FWER(3)) | (1.6) | (1.0) | (2.4) | (1.0) | (1.9) | (4.0) | (1.2) | (1.8) | (3.3) |
| | Model Correlation ρ = 0.4 | | | | | | | | |
| Step-RC | 9.2 | 29.1 | 77.4 | 7.9 | 23.1 | 71.9 | 5.0 | 16.8 | 65.3 |
| (FWER) | (0.7) | (0.6) | (0.9) | (1.7) | (0.9) | (0.5) | (1.5) | (0.7) | (1.6) |
| Step-SPA | 14.6 | 39.0 | 80.2 | 12.0 | 31.6 | 80.3 | 7.7 | 23.3 | 73.9 |
| (FWER) | (2.2) | (2.7) | (2.0) | (3.3) | (2.4) | (2.0) | (2.5) | (2.3) | (2.6) |
| Step-RC(3) | 20.8 | 47.8 | 89.9 | 16.7 | 39.5 | 86.0 | 10.8 | 29.6 | 79.8 |
| (FWER(3)) | (0.6) | (0.1) | (0.6) | (0.0) | (0.6) | (0.1) | (0.7) | (0.6) | (0.7) |
| Step-SPA(3) | 34.5 | 66.4 | 97.0 | 27.0 | 56.0 | 94.7 | 17.4 | 43.2 | 90.8 |
| (FWER(3)) | (2.2) | (2.8) | (2.2) | (2.9) | (3.2) | (3.4) | (2.5) | (2.6) | (3.8) |

Note:
S is the number of models,
n is the number of observations, and
ρ is the correlation coefficient between models.
Empirical FWER, FWER(3), and average powers are all expressed in percentages;
the nominal significance level is α = 5%.

TABLE 4
Average power performance and control of FWER: t(4) variables.

| | S = 100 | | | S = 200 | | | S = 500 | | |
|---|---|---|---|---|---|---|---|---|---|
| | n = 100 | n = 200 | n = 500 | n = 100 | n = 200 | n = 500 | n = 100 | n = 200 | n = 500 |
| | Model Correlation ρ = 0 | | | | | | | | |
| Step-RC | 8.7 | 24.2 | 73.1 | 6.0 | 18.5 | 66.9 | 3.8 | 13.4 | 58.3 |
| (FWER) | (0.5) | (0.4) | (0.2) | (0.4) | (0.4) | (0.5) | (0.7) | (0.4) | (0.2) |
| Step-SPA | 14.3 | 34.9 | 82.6 | 10.4 | 27.8 | 76.8 | 6.4 | 20.1 | 68.6 |
| (FWER) | (1.2) | (1.6) | (2.3) | (1.5) | (1.5) | (1.4) | (2.0) | (0.9) | (0.9) |
| Step-RC(3) | 26.3 | 53.4 | 92.7 | 19.0 | 44.1 | 88.6 | 11.7 | 32.2 | 81.6 |
| (FWER(3)) | (0.0) | (0.0) | (0.0) | (0.0) | (0.0) | (0.0) | (0.0) | (0.0) | (0.0) |
| Step-SPA(3) | 44.5 | 74.7 | 98.3 | 33.6 | 65.0 | 96.7 | 21.1 | 49.6 | 93.1 |
| (FWER (3)) | (0.3) | (1.0) | (1.6) | (0.3) | (0.3) | (2.8) | (0.3) | (0.3) | (2.6) |
| | Model Correlation ρ = 0.2 | | | | | | | | |
| Step-RC | 0.5 | 25.4 | 75.0 | 6.8 | 20.9 | 68.4 | 4.2 | 14.6 | 60.3 |
| (FWER) | (0.6) | (0.5) | (0.5) | (0.6) | (0.4) | (0.5) | (0.6) | (0.6) | (0.3) |
| Step-SPA | 15.0 | 36.1 | 83.7 | 11.1 | 29.9 | 77.8 | 6.9 | 21.2 | 70.0 |
| (FWER) | (1.2) | (1.5) | (1.9) | (1.8) | (1.5) | (2.3) | (1.6) | (1.8) | (1.1) |
| Step-RC(3) | 23.2 | 48.6 | 90.4 | 16.8 | 40.5 | 85.7 | 10.5 | 29.2 | 78.5 |
| (FWER(3)) | (0.0) | (0.0) | (0.0) | (0.0) | (0.0) | (0.0) | (0.0) | (0.3) | (0.2) |
| Step-SPA(3) | 38.8 | 69.2 | 97.7 | 29.1 | 59.4 | 95.2 | 18.1 | 44.2 | 90.7 |
| (FWER(3)) | (0.6) | (1.5) | (2.2) | (0.6) | (1.4) | (3.2) | (0.5) | (1.7) | (2.6) |
| | Model Correlation ρ = 0.4 | | | | | | | | |
| Step-RC | 11.1 | 28.9 | 77.9 | 8.2 | 25.1 | 72.2 | 5.4 | 17.9 | 65.1 |
| (FWER) | (0.7) | (0.6) | (0.9) | (0.8) | (0.9) | (1.2) | (0.9) | (1.5) | (0.6) |
| Step-SPA | 16.8 | 39.1 | 85.4 | 12.3 | 33.6 | 80.4 | 8.3 | 24.6 | 73.6 |
| (FWER) | (1.7) | (1.4) | (2.3) | (1.5) | (1.8) | (1.9) | (2.0) | (2.4) | (1.7) |
| Step-RC(3) | 23.1 | 48.4 | 90.3 | 17.0 | 41.3 | 85.6 | 11.2 | 30.6 | 79.4 |
| (FWER(3)) | (0.0) | (0.0) | (0.2) | (0.1) | (0.3) | (0.3) | (0.2) | (0.9) | (0.4) |
| Step-SPA(3) | 36.9 | 66.4 | 97.2 | 27.7 | 58.0 | 94.3 | 18.1 | 44.0 | 89.9 |
| (FWER(3)) | (1.2) | (1.6) | (2.7) | (1.2) | (2.8) | (3.4) | (2.0) | (3.1) | (3.2) |

Note:
S is the number of models,
n is the number of observations, and
ρ is the correlation coefficient between models.
Empirical FWER, FWER(3), and average powers are all expressed in percentages;
the nominal significance level is α = 5%.

### Example 2

### Evaluation of Commodity Trading Advisor Funds

This example shows an embodiment of the Step-SPA(k) test on assessing the performance of Commodity Trading Advisor (CTA) funds, a subset of Macro hedge funds according to the categorization of Hedge Fund Research, Inc. A CTA fund mainly trades futures and forwards in commodities and financial instruments. There were two main strategies employed by CTA funds: systematic and discretionary. A systematic fund used trading rules based on quantitative variables such as technical indicators, fundamental information and/or macro statistics. A discretionary fund traded mainly based on the past trading experience of the fund manager. The CTA fund family had been under the spotlight of the investment industry since the 2008 financial crisis because of its low correlation with traditional financial assets such as stocks and bonds, and its relatively good performance in 2008, as compared to mutual funds and other hedge funds.

The monthly data on CTA funds were taken from the Hedge Fund Research database, which is a leading database in hedge fund research. There were 1050 funds during the period of July 1994 to June 2010. This embodiment excluded the first 12 months of data in the subsequent analysis, so as to mitigate the incubation bias. Certain “tiny” funds, those with assets under management less than $20 million, were also excluded because they are often not available to general investors. There were 315 remaining funds.

To assess fund performance, the Capital Asset Pricing Model (CAPM) and the other two factor models were employed. The CAPM is: rₜ^{e}=α^{e}+β^{e}(R_{m,t}−R_{f,t})+εₜ^{e}, where rₜ^{e} is the t-th month return of the e-th fund in excess of R_{f,t}, the one-month treasury bill rate, and R_{m,t} the t-th month return on the US stock markets, which is the value-weighted return on all NYSE, AMEX, and NASDAQ stocks from the CRSP database. We also considered the K-factor model as: rₜ^{e}=α^{e}+Σₖ₌₁^{K}βₖ^{e}F_{k,t}+εₜ^{e}, where F_{k,t} denotes the k-th factor. A 4-factor model was embodied to evaluate performance, where F_{k,t} represented the excess return of the value-weighted US stock market index (i.e., R_{m,t}), size factor, value factor, and previous one-year momentum. Additionally, a 5-factor model was taken into account, where F_{k,t} can denote the t-th month return of the lookback straddle on the following five underlying futures markets: bond, currency, commodity, short-term interest rate, and stock index. Other models or other K-factor models for performance assessment are used in additional embodiments.

The statistical tests of Step-SPA(k) and Step-RC(k), k=1, 2, 3 were applied to identify outperforming funds from all funds and from two sub-groups: discretionary funds and systematic funds. For every fund in each group, performance was evaluated based on the t-ratio of the estimated α^{e} in the CAPM, 4-factor model, and 5-factor model. Step-SPA(k) and Step-RC(k) were computed as in our simulations, except that \hat{σ}_{e,n} in the standardized test statistics were obtained from a prewhitened HAC-consistent covariance matrix estimate based on the quadratic spectral kernel, and the critical values were computed using the stationary bootstrap. The standardization in the bootstrap was carried out as the second bootstrap method discussed in Example 1. The statistics and critical values were thus robust to possible serial correlations in data. The expected block length in the stationary bootstrap was 4, and the number of bootstraps was 1000. Note that the results were not affected by other choices of block length.

When CTA funds did not survive a long period of time, the number of identified funds based on two arbitrarily chosen, 10-year sample periods (July 1996 to June 2006 and July 1998 to June 2008) were reported. The summary statistics of the data in these two sample periods were collected in Table 5. It is readily seen that the data in these two samples were skewed to the right and clearly deviating from normality. The testing results based on the period from July 1998 to June 2008 were given in Table 6, where the upper and lower panels contain the results under the nominal levels FWER(k)=5% and FWER(k)=10%, respectively. Similarly, the testing results based on the period from July 1996 to June 2006 were summarized in Table 7.

From the upper panel of Table 6, for a given k, the number of funds identified by Step-SPA(k) was no less than that by Step-RC(k). The power advantage of Step-SPA(k) was more prominent when k=3. In particular, Step-SPA(3) was able to identify more outperforming funds from all funds and from systematic funds when the performance measure was based on the 4- and 5-factor models. As there were only 14 discretionary funds, Step-SPA(3) and Step-RC(3) tended to identify the same number of funds. Since the number of identified funds varied across different models, the funds that were identified by all 3 models were also reported. It can be seen that Step-SPA(k) again selected more funds from systematic funds. When FWER(k)=10%, the conclusions were similar (see lower panel of Table 6), except that Step-SPA(k) with k=2 now also showed power advantage over Step-RC(k).

For the results in Table 7, Step-SPA(k) and Step-RC(k) had very similar performance in most cases when FWER(k)=5% (upper panel). Yet when FWER(k)=10%, the power advantages of Step-SPA(k) for k=2, 3 became apparent. It is also interesting to observe from both tables that the conventional Step-SPA test (i.e., Step-SPA(1)) typically had no power advantage relative to the conventional Step-RC(1) test, because the former did not identify more outperforming funds. This provides a justification that allowing for more false rejections (i.e., a larger k) in Step-SPA is practically desirable.

As a robustness check, if the performance of the identified funds persists was tested to see if it persisted over time. To this end, every 10 years as one in-sample period was taken and the following year as its out-of-sample period. This resulted in 6 in- and out-of-sample periods. (The first in-sample period was from July 1994 through June 2004 with the associated out-of-sample period from July 2004 through June 2005. The last in-sample period was from July 1999 through June 2009 with the out-of-sample period from July 2009 through June 2010.) An equally weighted portfolio from the funds identified from each in-sample period (based on Step-SPA and Step-SPA(3)) was constructed and its return in the out-of-sample period was computed. A factor model was then estimated using these out-of-sample returns. A bootstrap approach was used to test the significance of the abnormal return in this factor model. The out-of-sample results under the nominal level of 10% are summarized in Table 8. In general, these testing results supported that the funds identified by Step-SPA(3) continued to produce significantly abnormal returns out of sample. For example, for the funds identified from all funds, discretionary funds, and systematic funds by Step-SPA(3) using the 5-factor model, our testing results indicated that the estimated abnormal returns of those portfolios were significant at, respectively, 1%, 1%, and 10% levels.

TABLE 5
Summary of statistics of the data in two sample periods.

| | Sample July 1996-June 2006 | | | Sample July 1998-June 2008 | | |
|---|---|---|---|---|---|---|
| Statistic | All funds | Discretionary | Systematic | All funds | Discretionary | Systematic |
| mean | 0.940 | 0.920 | 1.084 | 0.862 | 0.830 | 1.008 |
| median | 0.500 | 0.520 | 0.413 | 0.419 | 0.400 | 0.468 |
| standard dev. | 5.187 | 5.282 | 4.639 | 4.808 | 4.872 | 4.708 |
| min | −36.500 | −23.330 | −36.500 | −36.500 | −20.540 | −36.500 |
| max | 47.100 | 47.100 | 44.270 | 47.100 | 47.100 | 44.980 |
| skewness | 0.897 | 0.906 | 0.826 | 0.891 | 0.837 | 1.110 |
| kurtosis | 0.262 | 5.106 | 12.716 | 6.806 | 5.136 | 14.816 |
| Number of funds | 68 | 54 | 11 | 77 | 63 | 14 |

TABLE 6
The number of funds identified by Step-SPA(k) and Step-RC(k)

| | | All funds | | | Discretionary | | | Systematic | | |
|---|---|---|---|---|---|---|---|---|---|---|
| Model | Test | k = 1 | 2 | 3 | k = 1 | 2 | 3 | k = 1 | 2 | 3 |

Nominal FWER(k) = 5%

| | | | | | | | | | | |
|---|---|---|---|---|---|---|---|---|---|---|
| CAPM | Step-RC(k) | 1 | 8 | 12 | 3 | 5 | 5 | 0 | 9 | 9 |
| | Step-SPA(k) | 1 | 8 | 12 | 3 | 5 | 5 | 0 | 9 | 9 |
| 4-factor | Step-RC(k) | 0 | 0 | 0 | 0 | 5 | 7 | 0 | 0 | 3 |
| | Step-SPA(k) | 0 | 0 | 4 | 0 | 5 | 7 | 0 | 1 | 5 |
| 5-factor | Step-RC(k) | 4 | 5 | 8 | 1 | 3 | 3 | 4 | 4 | 11 |
| | Step-SPA(k) | 4 | 5 | 10 | 1 | 3 | 3 | 4 | 9 | 16 |
| All 3 | Step-RC(k) | 0 | 0 | 0 | 0 | 2 | 3 | 0 | 0 | 3 |
| models | Step-SPA(k) | 0 | 0 | 0 | 0 | 2 | 3 | 0 | 1 | 5 |

Nominal FWER(k) = 10%

| | | | | | | | | | | |
|---|---|---|---|---|---|---|---|---|---|---|
| CAPM | Step-RC(k) | 3 | 12 | 14 | 3 | 5 | 13 | 5 | 9 | 12 |
| | Step-SPA(k) | 3 | 12 | 14 | 3 | 5 | 13 | 5 | 10 | 13 |
| 4-factor | Step-RC(k) | 0 | 0 | 9 | 0 | 6 | 7 | 0 | 2 | 5 |
| | Step-SPA(k) | 0 | 2 | 9 | 0 | 6 | 9 | 0 | 5 | 8 |
| 5-factor | Step-RC(k) | 4 | 14 | 21 | 3 | 3 | 8 | 4 | 16 | 25 |
| | Step-SPA(k) | 4 | 18 | 27 | 3 | 3 | 10 | 5 | 19 | 27 |
| All 3 | Step-RC(k) | 0 | 0 | 7 | 0 | 3 | 5 | 0 | 2 | 5 |
| models | Step-SPA(k) | 0 | 1 | 7 | 0 | 3 | 9 | 0 | 5 | 7 |

Notes:
There is a total of 77 funds, in which 14 are discretionary and 63 are systematic.

TABLE 7
The number of funds identified by Step-SPA(k) and Step-RC(k)

| | | All funds | | | Discretionary | | | Systematic | | |
|---|---|---|---|---|---|---|---|---|---|---|
| Model | Test | k = 1 | 2 | 3 | k = 1 | 2 | 3 | k = 1 | 2 | 3 |

Nominal FWER(k) = 5%

| | | | | | | | | | | |
|---|---|---|---|---|---|---|---|---|---|---|
| CAPM | Step-RC(k) | 1 | 1 | 7 | 1 | 5 | 7 | 0 | 4 | 8 |
| | Step-SPA(k) | 1 | 1 | 7 | 1 | 5 | 7 | 0 | 4 | 8 |
| 4-factor | Step-RC(k) | 1 | 3 | 3 | 1 | 3 | 7 | 0 | 1 | 1 |
| | Step-SPA(k) | 1 | 3 | 3 | 1 | 3 | 7 | 0 | 1 | 1 |
| 5-factor | Step-RC(k) | 1 | 6 | 12 | 1 | 5 | 8 | 0 | 7 | 13 |
| | Step-SPA(k) | 1 | 8 | 13 | 1 | 5 | 8 | 0 | 7 | 13 |
| All 3 | Step-RC(k) | 1 | 1 | 1 | 1 | 2 | 6 | 0 | 0 | 0 |
| models | Step-SPA(k) | 1 | 1 | 1 | 1 | 2 | 6 | 0 | 0 | 0 |

Nominal FWER(k) = 10%

| | | | | | | | | | | |
|---|---|---|---|---|---|---|---|---|---|---|
| CAPM | Step-RC(k) | 1 | 7 | 12 | 1 | 6 | 8 | 0 | 8 | 13 |
| | Step-SPA(k) | 1 | 8 | 13 | 1 | 6 | 8 | 0 | 9 | 14 |
| 4-factor | Step-RC(k) | 1 | 3 | 7 | 2 | 5 | 7 | 1 | 1 | 7 |
| | Step-SPA(k) | 2 | 3 | 7 | 2 | 7 | 9 | 1 | 1 | 7 |
| 5-factor | Step-RC(k) | 2 | 12 | 18 | 2 | 5 | 8 | 1 | 12 | 18 |
| | Step-SPA(k) | 2 | 13 | 18 | 2 | 5 | 9 | 1 | 13 | 18 |
| All 3 | Step-RC(k) | 1 | 1 | 4 | 1 | 4 | 6 | 0 | 0 | 6 |
| models | Step-SPA(k) | 1 | 1 | 4 | 1 | 5 | 8 | 0 | 0 | 6 |

Notes:
There is a total of 65 funds, in which 11 are discretionary and 54 are systematic.

TABLE 8
Persistence test of standarized alpha of equally weighted portfolios based on
selected CTA funds.

| | CAPM | | | 4-factor model | | | 5-factor model | | |
|---|---|---|---|---|---|---|---|---|---|
| | All | Disc. | Syst. | All | Disc. | Syst. | All | Disc. | Syst. |
| | Funds selected by Step-SPA | | | | | | | | |
| alpha | −0.105 | 0.005 | 0.877 | −0.425 | −0.690 | −1.342 | 2.398 | 1.750 | 1.922 |
| p-value | 0.419 | 0.974 | 0.120 | 0.742 | 0.696 | 0.909 | <0.0001 | <0.0001 | 0.019 |
| | Funds selected by Step-SPA(3) | | | | | | | | |
| alpha | 0.943 | 2.562 | 0.687 | 0.160 | 2.908 | 0.641 | 2.818 | 2.941 | 2.666 |
| p-value | 0.015 | <0.0001 | 0.387 | 1.000 | 0.008 | 0.022 | <0.0001 | <0.0001 | 0.096 |

Notes:
alpha denotes regression standardized alpha;
p-value is bootstrapped p-value.
The funds for the portfolios are selected by CAPM, 4-factor model, and 5-factor model under FWER(k) = 10%.

### Example 3

### Software Implementation of the Financial Model Rating System

FIG. 8 illustrates an example user interface for evaluating and selecting superior financial models, in accordance with at least one embodiment. In this embodiment, a user interface was configured to receive user-entered parameters for a model evaluation process, enabling a user to take actions regarding the model evaluation process and/or to display the results to the user. Various embodiments of the user interface are contemplated.

In this example, the user interface included one or more input controls for a user to enter parameter information related to a model evaluation process. The input controls included text fields, boxes, selections, and dropdown lists. Other suitable input controls may be implemented dependent on the application. In this example, a financial model type can be selected from a list of available types such as hedge funds, mutual funds, CTAs, trading rules, and the like. The user interface also included an error rate input control where a user selected the value of k. The user interface further included a performance metric input control where a user may select a performance metric to measure from a list of available performance metrics such as mean risk, drawdown, excess return, Sharpe ratio, alpha, standardized alpha, information ratio, GIS MPPM, and the like.

The user interface included a factor model input control where a user may specify the formula used to calculate or measure the performance of a model from an available list of formulas such as CAPM, Brown-Geotzmann-Ibbotson 1-factor model, Fama-French 3-factor model, Fama-French-Carhart 4-factor model, Fung-Hsieh 5-factor model, Fung-Hsieh 7-factor model, Fung-Hsieh 8-factor model, Capocci-Hübner 11-factor model, and the like. The user interface included a time range input control where a user may specify the time range of performance data to measure, such as from January, 2005 to December 2012. The user may select the time range from a calendar control, dropdown list, or the like, or enter the time range directly in a text field or box. The user interface included a measurement frequency input control where a user may specify the frequency at which data is sampled from the performance data. For example, the user may select the frequency from a list of available frequencies such as every 30 minutes, hourly, every two hours, every four hours, daily, weekly, monthly, yearly and the like. The user interface included a model number input control where a user may specify the total number of models to be evaluated. For example, the user entered the number (e.g., 200) directly into a text field.

### Example 4

### Algorithm Implementation of the Financial Model Rating System

The algorithm embodiment of financial model rating and selection controlling the false discovery proportion based on Step-SPA(k) is as follows. The system was given m financial models. The parameters of the system contain: an integer number n of data observations, a threshold γ of false discovery proportion, and a significance level α. In this embodiment, 1≦n≦5000, 0<γ<1, and 0<α<1. A counter k was initialized as k=1. Then, the significance level α was used to iterate the Step-SPA(k) test underlying this algorithm. The algorithm is summarized below.
(a) Initialize k=1.
(b) Compute a test statistic \hat{T}_{e,n} for each model e. Re-index the financial models such that \hat{T}_{e,n} were in a descending order; i.e., \hat{T}_{1,n}≧\hat{T}_{2,n}> . . . ≧\hat{T}_{m,n}.
(c) Use all the financial models to compute a critical value ŵₙ(1−α,k)=\hat{q}ₙ(1−α,k). If max{\sqrt{n}\hat{T}_{e,n}}≦ŵₙ(1−α,k), then accept all hypotheses and jump to step (f); otherwise, reject the e-th model if \sqrt{n}\hat{T}_{e,n}>ŵₙ(1−α,k) and continue.
(d) Let R be the collection of the indices e of the rejected financial models, and let A be the collection of the indices of the remaining non-rejected hypotheses. If the number of rejected models was smaller than k (i.e., |R|<k), then jump to step (f); otherwise, enumerate all the subsets of R with size k−1, make a union of each subset and the set A, and compute a critical value ŵₙ(1−α,k) of all the unions (i.e., let ŵₙ(1−α,k)=max_{I⊂R,|I|=k-1}{\hat{q}_{n,K}(1−α,k):K=A∪I}).
(e) If max{\sqrt{n}\hat{T}_{e,n}}≦ŵₙ(1−α,k), then accept all hypotheses and jump to step (f); otherwise, reject the e-th model if \sqrt{n}\hat{T}_{e,n}>ŵₙ(1−α,k) and go back to step (d).
(f) Let Nₖ denote the number of the rejected hypotheses.
(g) If

$${N}_{k} < \frac{k}{γ} - 1 ,$$

stop and reject all hypotheses indicated by R; otherwise, set k=k+1 and return to step (c).
(h) Present the superior models corresponding to the hypotheses indicated by R.

### Example 5

### Application on Mutual Fund Rating and Selection

This example shows the application of the subject system on mutual funds selection. The system developed herein was given 240 mutual funds invested in global stock markets. The embodied system used the false-discovery-proportion-control algorithm based on the Step-SPA(k) test. In this example, the system was used to identify superior mutual funds, and the whole capital was invested in the superior mutual funds. The investment performance was further evaluated. The false discovery proportion was set below 50%, and the significance level was set below 30%. The k used in this example was between 2 and 50. Every month from February 2005 to February 2014, the system adjusted the investment by selecting a new set of superior mutual funds and reallocating the investment holdings accordingly.

The monthly gains of the portfolio governed by the subject system are summarized in Table 9, and displayed in the bar chart of FIG. 9. Notably, the disclosed system achieved more than doubling gains than the MSCI world index in years 2005, 2007, 2009, and 2013. Most importantly, in the 2008 financial crisis, the annual loss by the disclosed system was 55% less than the loss in the global market. The line curves in FIG. 9 show the accumulated gains during the entire test period. The line curves show that the exemplary portfolio achieved a 564% gain at the end of February 2014, while the MSCI World Stock Index only achieved 91% gain during the same period. This example illustrates a lower risk, higher performance achieved by the developed system. The unexpected, promising gains demonstrated the extraordinary performance of the system developed in this application.

TABLE 9
Annual gains using the mutual fund rating and selection developed in this application.

| | Year | | | | | | | | | |
|---|---|---|---|---|---|---|---|---|---|---|
| | 2014 | 2013 | 2012 | 2011 | 2010 | 2009 | 2008 | 2007 | 2006 | 2005 |
| January | 2.67% | 7.38% | 8.95% | −11.16% | −7.10% | −1.99% | −20.37% | 1.54% | 4.98% | |
| February | 6.33% | 2.37% | 6.20% | 6.46% | 0.99% | −2.49% | 12.24% | 3.96% | 2.51% | |
| March | | 1.24% | 0.88% | −0.26% | 7.79% | 12.38% | −4.69% | 2.48% | 2.57% | −2.50% |
| April | | 2.48% | −0.94% | 2.49% | 2.11% | 8.56% | 6.91% | 1.57% | 4.75% | −2.55% |
| May | | 1.90% | −6.25% | −0.64% | −8.88% | 20.99% | 2.34% | 3.97% | −6.61% | 1.81% |
| June | | −0.93% | 2.56% | 0.11% | −1.59% | −1.45% | −3.66% | 2.06% | −8.53% | 3.32% |
| July | | 14.73% | 3.69% | 0.11% | 7.11% | 7.60% | −12.92% | 6.76% | −0.08% | 15.27% |
| August | | −1.63% | 1.88% | 0.11% | −1.26% | −1.52% | −8.89% | −7.61% | 6.92% | −0.83% |
| September | | 9.45% | 2.46% | 0.11% | 10.39% | 8.65% | 0.23% | 20.62% | 1.18% | 6.96% |
| October | | −6.01% | −1.90% | 0.11% | 4.66% | 1.98% | 0.21% | 13.25% | −0.04% | −7.23% |
| November | | 6.77% | 2.11% | 0.11% | −1.60% | 7.30% | 0.18% | −12.40% | 2.98% | 9.67% |
| December | | 1.48% | 1.16% | −0.53% | 4.88% | 1.19% | 15.49% | −2.11% | 5.24% | 7.80% |
| Annual Gain | 9.18% | 44.85% | 21.94% | −3.79% | 16.75% | 77.22% | −17.20% | 34.72% | 15.70% | 34.01% |
| (This Application) | | | | | | | | | | |
| MSCI Word | 1.19% | 27.37% | 16.54% | −5.02% | 12.34% | 30.79% | −40.33% | 9.57% | 20.65% | 9.03% |
| Index Gain | | | | | | | | | | |

What is claimed is:

1. Non-transitory computer-readable storage media encoded with a computer program including instructions executable by a processor to create an application comprising
(a) a software module configured to acquire data of a plurity of financial models;
(b) a software module configured to select at least one benchmark model, wherein the benchmark model is indicated by a user or automatically determined;
(c) a software module configured to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and
(d) a software module configured to set one or more criteria for evaluating the performance.

2. The media of claim 1, wherein the stepwise-superior-predictive-ability test comprises:
(a) initializing a counter to be 1 and a set of rejected financial models to be an empty set;
(b) computing a test statistic for each financial model, wherein the test statistic comprises a performance measure of the financial model;
(c) computing a critical value of one or more subsets of the financial models, wherein the one or more subsets of the financial models are defined by the counter and the set of rejected financial models;
(d) rejecting a financial model whose test statistic is greater than the critical value;
(e) terminating the stepwise-superior-predictive-ability test if the number of rejected financial models is smaller than the counter, or incrementing the counter by 1 and repeating the step (c); and
(f) presenting all rejected financial models as the superior models.

3. The media of claim 1 further comprising a software module configured to set an analysis frequency for the stepwise-superior-predictive-ability test to evaluate the financial models.

4. The media of claim 1 further comprising a software module configured to set a performance metric for the stepwise-superior-predictive-ability test to evaluate the financial models.

5. The media of claim 1 further comprising a software module configured to display the identified superior models.

6. The media of claim 1 further comprising a software module configured to control the access of a remote user to the identified superior models.

7. The media of claim 1 further comprising a software module configured to link with a broker to trade the identified superior models.

8. The media of claim 1, wherein the financial models comprise one or more of: investment portfolios, stocks, options, futures, swaps, foreign exchanges, exchange-traded funds, commodities, real estate, assets, commodity trading advisor funds, mutual funds, and hedge funds.

9. The media of claim 1, wherein the application is offered as software as a service.

10. A computer-implemented system comprising
(a) a digital processing device comprising a memory device and an operating system configured to perform executable instructions;
(b) a computer program including instructions executable by the digital processing device to create an application, wherein the application comprising:
(1) a software module configured to acquire data of a plurity of financial models;
(2) a software module configured to select at least one benchmark model, wherein the benchmark model is indicated by a user or automatically determined;
(3) a software module configured to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and
(4) a software module configured to set one or more criteria for evaluating the performance.

11. The system of claim 10, wherein the stepwise-superior-predictive-ability test comprises:
(a) initializing a counter to be one and a set of rejected financial models to be an empty set;
(b) computing a test statistic for each financial model, wherein the test statistic comprises a performance measure of the financial model;
(c) computing a critical value of one or more subsets of the financial models, wherein the one or more subsets of the financial models are defined by the counter and the set of rejected financial models;
(d) rejecting a financial model whose test statistic is greater than the critical value;
(e) terminating the stepwise-superior-predictive-ability test if the number of rejected financial models is smaller than the counter, or incrementing the counter by one and repeating the step (c); and
(f) presenting all rejected financial models as the superior models.

12. The system of claim 10, wherein the application further comprises a software module configured to set an analysis frequency for the stepwise-superior-predictive-ability test to evaluate the financial models.

13. The system of claim 10, wherein the application further comprises a software module configured to set a performance metric for the stepwise-superior-predictive-ability test to evaluate the financial models.

14. The system of claim 10, wherein the application further comprises a software module configured to display the identified superior models.

15. The system of claim 10, wherein the application further comprises a software module configured to control the access of a remote user to the identified superior models.

16. The system of claim 10, wherein the application further comprises a software module configured to link to a broker to trade the identified superior models.

17. The system of claim 10, wherein the financial models comprise one or more of: investment portfolios, stocks, options, futures, swaps, foreign exchanges, exchange-traded funds, commodities, real estate, assets, commodity trading advisor funds, mutual funds, and hedge funds.

18. A computer implemented method comprising
(a) acquiring by a computer the data of a plurity of financial models;
(b) selecting by a computer at least one benchmark model; and
(c) utilizing by a computer a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate.

19. The method of claim 18, wherein the stepwise-superior-predictive-ability test comprises:
(a) initializing a counter to be one and a set of rejected financial models to be an empty set;
(b) computing a test statistic for each financial model, wherein the test statistic comprises a performance measure of the financial model;
(c) computing a critical value of one or more subsets of the financial models, wherein the one or more subsets of the financial models are defined by the counter and the set of rejected financial models;
(d) rejecting a financial model whose test statistic is greater than the critical value;
(e) terminating the stepwise-superior-predictive-ability test if the number of rejected financial models is smaller than the counter, or incrementing the counter by one and repeating step (c); and
(f) presenting all rejected financial models as the superior models.

20. An electronics system comprising
(a) a digital processing device comprising a memory device and an operating system configured to perform executable instructions;
(b) a data reader configured by the digital processing device to acquire data of a plurity of financial models;
(c) a benchmark model selector configured by the digital processing device to determine at least one benchmark model;
(d) a statistical analyzer configured by the digital processing device to use a stepwise-superior-predictive-ability test to evaluate performance of the financial models with respect to the benchmark model, rank the financial models, and identify one or more superior models from the financial models, wherein the stepwise-superior-predictive-ability test controls a generalized family-wise error rate; and
(e) a reporter configured by the digital processing device to present one or more selected financial models.

21. The system of claim 20, wherein the stepwise-superior-predictive-ability test comprises:
(a) initializing a counter to be one and a set of rejected financial models to be an empty set;
(b) computing a test statistic for each financial model, wherein the test statistic comprises a performance measure of the financial model;
(c) computing a critical value of one or more subsets of the financial models, wherein the one or more subsets of the financial models are defined by the counter and the set of rejected financial models;
(d) rejecting a financial model whose test statistic is greater than the critical value;
(e) terminating the stepwise-superior-predictive-ability test if the number of rejected financial models is smaller than the counter, or incrementing the counter by one and repeating step (c); and
(f) presenting all rejected financial models as the superior models.
